(19) United States
(12) Patent Application Publication
(10) Pub. No.: US 2022/0112442 A1
(43) Pub. Date: Apr. 14, 2022

(54) Cationically modified polyurethane dispersions as textile softeners

(71) Applicant: Henkel AG & Co. KGaA, Duesseldorf (DE)

(72) Inventors: Sascha SCHAEFER, Mettmann (DE); Ligang ZHAO, Duesseldorf (DE); Tatiana SCHYMITZEK, Krefeld (DE)

(21) Appl. No.: 17/498,009

(22) Filed: Oct. 11, 2021

(30) Foreign Application Priority Data
Oct. 12, 2020 (DE) 10 2020 126 698.7

(51) Int. Cl. C11D 3/00; C11D 11/00; C11D 3/37

(52) U.S. Cl. CPC C11D 3/001; C11D 3/3726; C11D 11/0017

(57) ABSTRACT

A method of forming a textile treatment agent may include emulsifying at least one cationically modified prepolymer into an aqueous phase, and cross-linking the emulsified prepolymer to form the dispersion having the at least one cationically modified polyurethane. The cationically modified polyurethane dispersions may be used as textile softeners, as textile treatment agents, and the like.

### CROSS-REFERENCE TO RELATED APPLICATION

The present patent application claims priority, according to 35 U.S.C. § 119, from German Patent Application No. 10 2020 126 698.7 filed on Oct. 12, 2020, the entire disclosure of which is incorporated herein by reference.

### TECHNICAL FIELD

The present disclosure relates to the cationically modified polyurethane dispersions as textile softeners, particularly to a textile treatment agent containing at least one such cationically modified polyurethane dispersion, and to a method for treating textiles using at least one such agent or at least one such cationically modified polyurethane dispersion.

### BACKGROUND

Repeated washing often causes textiles to become hard and lose their softness. In order to restore textiles to their softness/flexibility, to give them a pleasant scent and/or to improve their antistatic properties, the textiles are treated using a fabric softener after the actual washing and cleaning process in a subsequent rinsing process.

Common main active constituents of such fabric softeners are cationic textile-softening compounds, for example those which have one or two long-chain alkyl groups in a molecule. Widely used cationic textile-softening compounds include, for example, methyl-N-(2-hydroxyethyl)-N,N-di(tallowacyloxyethyl)ammonium compounds, methyl-N-(2-hydroxyethyl)-N,N-di(tallowacyloxyethyl)ammonium compounds or N,N-dimethyl-N,N-di(tallowacyloxyethyl)ammonium compounds. Esterquats (EQ), the term being generally understood to mean quaternized fatty acid triethanolamine ester salts, are broadly suitable for both fiber and hair finishing (avivage) and, due to their better ecotoxicological compatibility, the above quaternary ammonium compounds have largely been driven out of the market in recent years. However, since most esterquats have relatively long fatty acid chains, rapid biodegradability is not necessarily always ensured. In addition, non-polar side chains can result in an overall reduced affinity for the fibers of the textile to be conditioned.

Consequently, there continues to be a need for biodegradable, more polar compounds which are suitable for imparting softness to textiles.

### SUMMARY

This problem is solved by using cationically modified polyurethane dispersions as textile softeners.

The present disclosure therefore firstly relates to the use of a dispersion of at least one cationically modified polyurethane as a textile softener in textile treatment methods.

In a further aspect, the present disclosure relates to a textile treatment agent comprising at least one dispersion of at least one cationically modified polyurethane.

In a further aspect, the disclosure also relates to a method for conditioning textiles, characterized in that at least one dispersion of at least one cationically modified polyurethane and/or at least one textile treatment agent, as defined herein, is used in at least one method step.

These and other aspects, features and advantages of the disclosure will become apparent to a person skilled in the art through the study of the following detailed description and claims. Any feature from one aspect of the disclosure can be used in any other aspect of the disclosure.

A textile treatment agent, as described herein, is in particular a fabric softener.

Fabric softeners are added to the laundry in the last rinse cycle of the machine wash in order to prevent the “drying rigidity” effect that occurs when the laundry is drying. The drying rigidity is caused by the formation of hydrogen bonds between the cellulose fibers. The cationic active ingredients of the fabric softener penetrate the fiber or lie on the fiber surface, combine with the negative charges and thus weaken the interactions. Due to the reduced stiffness of the item of laundry, the effort required for ironing is reduced and the wearing comfort is increased.

Accordingly, the means described herein are particularly suitable for conditioning textile fabrics.

### DETAILED DESCRIPTION

As used herein, the term “conditioning” denotes imparting a desired property, for example, in relation to textiles, a pleasant feel, crease resistance or low static charge.

“At least one,” as used herein, includes, but is not limited to, 1, 2, 3, 4, 5, 6, and more. In relation to an ingredient, the expression refers to the type of ingredient and not to the absolute number of molecules. “At least one surfactant” thus means, for example, at least one type of surfactant, i.e., one type of surfactant or a mixture of several different surfactants can be meant. Together with weight specifications, the expression relates to all compounds of the type indicated that are contained in the composition/mixture, i.e., the composition does not contain any other compounds of this type beyond the indicated amount of the corresponding compounds.

Unless indicated otherwise, all percentages are indicated in terms of wt. %. Numerical ranges that are indicated in the format “from x to y” also include the stated values. If several preferred numerical ranges are indicated in this format, it is readily understood that all ranges that result from the combination of the various endpoints are also included.

“Approximately” or “ca.” as used herein in connection with a numerical value relates to the numerical value±10%, preferably ±5%.

When reference is made herein to molar masses, this information always refers to the number-average molar mass Mₙ, unless explicitly indicated otherwise. The number-average molar mass can, for example, be determined by gel permeation chromatography (GPC) according to DIN 55672-1:2007-08 with THF as the eluent. The number-average molar mass M_{w} can also be determined by means of GPC, as described for Mₙ.

Whenever alkaline earth metals are mentioned in the following as counterions for monovalent anions, this means that the alkaline earth metal is naturally only present in half the amount of the substance—sufficient to balance the charge—as the anion.

“Liquid,” as used herein, denotes all flowable compositions (at 20° C., 1.013 bar), including gels and paste-like compositions, and also non-Newtonian liquids that have a yield point.

“Solid,” as used herein, denotes a powder composition, granulate composition, extrudate composition or compact composition.

“Phosphate-free” and “phosphonate-free,” as used herein, mean that the composition in question is substantially free of phosphates or phosphonates, i.e., contains in particular phosphates or phosphonates in amounts of less than 0.1 wt. %, preferably less than 0.01 wt. %, based on the particular composition.

An agent can be a single-component agent or a multi-component agent. As used herein, the term “single-component agent” denotes an agent which consists of only one single component. The term “multi-component agent,” as used herein, denotes, in contrast, an agent which is composed of at least two components. It is preferred that the individual components of a multi-component agent are spatially separated from one another.

The expression “spatially separated” in relation to the components of the agent, as used herein, means that the individual components cannot come into contact with one another before the agent is used. Usually, the agent is provided in a multi-chamber packaging, such as a bottle, tube or a pouch, in particular a two-chamber bottle or a two-chamber pouch, with each individual component being located in a separate chamber so as to be separated from the other component(s).

The spatial separation of individual components of the agent makes it possible to separate incompatible ingredients from one another and to offer, in combination, several different components of the agent which are used at different times.

In this context, the term “component” denotes a part of the agent which can be distinguished from any further component of the agent on the basis of one or more features, for example the type and/or amount of its ingredients, physical properties, external appearance, etc. Individual components of the agent can be present in liquid form, as defined herein, or in solid form, as defined herein, and advantageously spatially separated from one another.

In some embodiments, a textile treatment agent is preferably a liquid textile treatment agent, as defined herein.

As surprisingly found, dispersions of cationically modified polyurethanes demonstrate a softening effect on textile fibers, in particular on cotton fibers, when they are brought into contact with laundry in the course of a rinsing process after the actual washing step. In order to be able to achieve such an effect, even low concentrations of such a dispersion are sufficient. The cationically modified polyurethanes are not only toxicologically harmless and are easily deposited on negatively charged substrates such as keratin, hair, leather and cotton, but also have an antistatic and antimicrobial effect.

Accordingly, a first aspect is directed to the use of a dispersion of at least one cationically modified polyurethane as a textile softener in textile treatment methods. In particular, the dispersion may be used as described below for conditioning, in particular for softening, textiles. The present disclosure relates to those uses in which a dispersion as described herein is used in a manual textile treatment method or, preferably, in the washing machine.

A dispersion of one or more cationically modified polyurethanes can in principle be obtained by dispersing at least one cationically modified polyurethane in an aqueous phase.

In various embodiments, a dispersion of a cationically modified polyurethane is obtainable in particular by

a) providing at least one cationically modified polyurethane prepolymer;
b) emulsifying the prepolymer from step a) into an aqueous phase; and
c) cross-linking the emulsified prepolymer from step b) in order to obtain a dispersion of a cationically modified polyurethane.

A combination of the above approaches is also possible, in that at least one cationically modified polyurethane prepolymer can be dispersed into an aqueous phase and at least one cationically modified polyurethane prepolymer can be dispersed into the same aqueous phase and then cross-linked.

Although basically any type of cationically modified polyurethane is suitable for use according to the present disclosure and as a constituent of a textile treatment agent, in particular of a fabric softener, functioning therein as a textile-softening component, as long as it is harmless for the particular application from a health and ecological point of view, i.e., is toxicologically harmless and biodegradable, those cationically modified polyurethanes are particularly preferred in the context of the present disclosure which are obtainable by cross-linking a polyurethane prepolymer, which in turn is obtainable by reacting
i) at least one organic compound (A) comprising at least one, preferably at least two, isocyanate-reactive functional groups and at least one cationic functional group, or a salt of compound (A),
   with
ii) at least one polyisocyanate compound (B)
   and optionally
iii) at least one polyol compound (C).

Correspondingly, in some embodiments, the above-mentioned step a) comprises reacting
i) at least one organic compound (A) comprising at least one, preferably at least two, isocyanate-reactive functional groups and at least one cationic functional group, or a salt of compound (A),
   with
ii) at least one polyisocyanate compound (B)
   and optionally
iii) at least one polyol compound (C).

In various embodiments, a compound (A) is a polyol comprising at least one cationic functional group, preferably a diol comprising at least one cationic functional group. In some embodiments, a cationic functional group is in particular an ammonium group, preferably a quaternary ammonium group.

Particularly suitable are those compounds (A) which are alkoxylated, in particular ethoxylated, propoxylated and/or butoxylated, dialkylammonium polyols, in particular dialkylammonium diols. A commercially available example is ethoxylated cocoalkylmethyl ammonium methanesulfonate. Such compounds are available, for example, under the trade name Rewoquat® CPEM from Evonik.

In various embodiments, a compound (A) is a compound of the formula

(N⁺(R)₃)—X (I),

where each R is independently H or a straight-chain, cyclic or branched, saturated or unsaturated or aromatic hydrocarbon group which has up to 50 carbon atoms, preferably up to 25 carbon atoms, more preferably up to 15 carbon atoms, and which may contain one or more groups selected from —O—, —(CO)— and —NH—;
and X is selected from straight-chain, cyclic or branched, saturated, unsaturated or aromatic, substituted or unsubstituted hydrocarbon groups having up to 5,000, for example having up to 5, 15, 20, 25, 30, 35, 40, 45, 50, 100, 150, 200, 300, 400, 500, 600, 700, 800, 900, 1,000, 1,500, 2,000, 2,500, 3,000, 3,500, 4,000, 4,500 or 5,000 carbon atoms, preferably having up to 500 carbon atoms, more preferably having up to 100 carbon atoms, even more preferably having up to 50 carbon atoms, in particular having up to 5, 6, 7, 8, 9, 10, 11, 12, 13, 14, 15, 16, 17, 18, 19 or 20 carbon atoms, X containing at least one, in particular at least two, but preferably not more than 10, even more preferably not more than 7, for example not more than 5-O—(Y)ₙ—H groups, where Y, with each occurrence, independently denotes a grouping selected from the group consisting of an ethylene oxide (EO), propylene oxide (PO) and a butylene oxide (BO) grouping, preferably from the group consisting of EO and PO, and n in each —O—(Y)ₙ—H group independently denotes an integer from 1 to 100, preferably 2 to 75, more preferably 2 to 50, and where X is furthermore optionally selected from one or more groups selected from —O—, —(CO)—, —NH— and —N(R¹)₂—, in particular one or more groups selected from —O—, —NH— and —N(R¹)₂—, where each R¹ is independently selected from straight-chain, cyclic or branched, saturated, unsaturated or aromatic, substituted or unsubstituted hydrocarbon groups having up to 20, preferably up to 10 carbon atoms, for example 1, 2, 3, 4, 5, 6, 7, 8, 9, or 10 carbon atoms. The —O—(Y)ₙ—H groups are excluded from the numbering of carbon atoms of the grouping X.

If present, substituents are selected from halogens, for example Cl. In various embodiments, the groups defined above are unsubstituted.

An —O—(Y)ₙ—H group, more precisely the terminal hydroxyl group of the —O—(Y)ₙ—H group, is an isocyanate-reactive functional group. In various embodiments, Y in each —O—(Y)ₙ—H group is identical, for example in some embodiments each Y in each —O—(Y)ₙ—H group of compound (A) denotes, with each occurrence, an ethylene oxide (EO) grouping. In some other embodiments, each Y in each —O—(Y)ₙ—H group of compound (A) denotes, with each occurrence, a propylene oxide (PO) grouping. In some further embodiments, each Y in each —O—(Y)ₙ—H group of compound (A) denotes, with each occurrence, a butylene oxide (BO) grouping. In various embodiments, an —O—(Y)ₙ—H group contains any mixture of ethylene oxide (EO), propylene oxide (PO) and butylene oxide (BO) groupings, the total number of groupings in an —O—(Y)ₙ—H group corresponding to n. In various embodiments, in a compound (A), at least one —O—(Y)ₙ—H group differs from the other —(Y)ₙ—H groups. For example, a compound (A) can be a compound of formula (I), as defined above, with Y in an —O—(Y)ₙ—H group denoting, with each occurrence, an EO grouping, and Y in a further —O—(Y)ₙ—H group denoting, with each occurrence, a PO grouping and/or Y in a further —O—(Y)ₙ—H group denoting, with each occurrence, a BO grouping. In various embodiments, all —O—(Y)ₙ—H groups in a compound (A) are different from one another. In various other embodiments, all —O—(Y)ₙ—H groups of a compound (A) are identical.

In various embodiments, compound (A) is a compound of formula (I), the groups R of which do not contain any heteroatoms and/or are unsubstituted. In various embodiments, the group X, apart from the at least one —O—(Y)ₙ—H group, does not contain any heteroatoms and/or is sub-substituted, i.e., does not contain, for example, a —N(R¹)₂— group. In various further embodiments, in particular in one of the two aforementioned preferred embodiments, the number of carbon atoms in the groups R is in each case preferably not more than 15 and/or the number of carbon atoms in group X is preferably not more than 50, in particular not more than 40, for example not more than 30, 25 or 15, the carbon atoms of the —O—(Y)ₙ—H group(s) of the grouping X not being included in this calculation. In further such embodiments, a group X contains at least one, preferably at least two, but preferably not more than 7, in particular not more than 5-O—(Y)ₙ—H groups, as defined herein. In further such preferred embodiments, the groups R are each, independently of one another, H or a straight-chain or branched alkyl group or alkylene group. In various further such preferred embodiments, n in each —O—(Y)ₙ—H group independently denotes an integer from 2 to 100, preferably from 2 to 80, even more preferably from 2 to 75, for example from 2, 3, 4, 5, 6, 7, 8, 9, 10, 11, 12, 13, 14, 15, 16, 17, 18, 19 or 20 to 25, 30, 35, 40, 45, 50, 55, 60, 65, 70 or 75, or from 2 to 3, 4, 5, 6, 7, 8, 9, 10, 11, 12, 13, 14, 15, 16, 17, 18, 19 or 20. In further such preferred embodiments, a compound (A) of formula (I) contains at least one —O—(Y)ₙ—H group, where Y denotes, with each occurrence, EO, and/or at least one —O—(Y)ₙ—H group, where Y denotes, with each occurrence, PO, and/or at least one —O—(Y)ₙ—H group, where Y denotes, with each occurrence, BO, and/or at least one —O—(Y)ₙ—H group, where Y is independently selected, with each occurrence, from EO, PO and BO; more preferably at least one —O—(Y)ₙ—H group, where Y denotes, with each occurrence, EO, and/or at least one —O—(Y)ₙ—H group, where Y denotes, with each occurrence, PO; even more preferably at least one —O—(Y)ₙ—H group, in particular at least two —O—(Y)ₙ—H groups, where Y denotes, with each occurrence, EO. Most preferably a compound of formula (I) comprises at least two —O—(Y)ₙ—H groups as defined herein.

Suitable salts of compound (A) include, but are not limited to, salts of compound (A) with acids. Examples of acids that are suitable in this context are acetic acid, formic acid, hydrochloric acid, phosphoric acid, sulfuric acid, nitric acid, nitrous acid, boric acid, carbonic acid, perchloric acid, acrylic acid, methacrylic acid, itaconic acid, maleic acid, 2-carboxyethyl acrylate, lactic acid, ascorbic acid, glycine, alanine, leucine, norleucine, phenylalanine, serine, taurine, valine, α-aminobutyric acid, palmitic acid, stearic acid, benzoic acid, mercaptoacetic acid, salicylic acid, pivalic acid, chloroacetic acid, dichloroacetic acid, trichloroacetic acid, citric acid, propionic acid, glycolic acid, 1-sulfonaphthalin, tartaric acid, phthalic acid, isophthalic acid, terephthalic acid, 5-sulfosalicylic acid, benzenesulfonic acid, cyclohexanecarboxylic acid, o-, m- and p-toluic acid, o-, m- and p-aminobenzoic acid, p-hydroxybenzoic acid, phenylacetic acid, methylbenzenesulfonic acid, butyric acid, valeric acid, oxalic acid, maleic acid, fumaric acid, malonic acid, succinic acid, glutaric acid, oleic acid, o-, m- and p-chlorobenzoic acid, o-, m- and p-bromobenzoic acid, anthranilic acid, o-, m- and p-nitrobenzoic acid, adipic acid, caprylic acid, caproic acid, 1-lauric acid, fluoroacetic acid, capric acid, myristic acid, methoxyacetic acid, dodecanesulfonic acid, dodecylbenzenesulfonic acid, ethylbenzenesulfonic acid, octanesulfonic acid, hexanesulfonic acid, polyacrylic acid, and copolymers of acrylic acid, methacrylic acid, itaconic acid, maleic acid and fumaric acid.

A polyisocyanate compound (B) is a compound which comprises at least two isocyanate groups. For example, a compound (B) can be a diisocyanate or a triisocyanate. In various embodiments it is preferred that the polyisocyanate is a diisocyanate. The incorporation of small amounts of isocyanate having a functionality of more than two, in particular a triisocyanate, is, however, also provided and can even be advantageous under certain circumstances. Such polyisocyanates can act as cross-linkers. In this case, when the polyisocyanate acts as a cross-linker, preference is given to polyisocyanates based on hexamethylene diisocyanate, for example in the form of corresponding isocyanurates. Allophanates of diisocyanates are also suitable. The amount of cross-linker is usually approximately 0 to 5 wt. %, preferably approximately 0 to 2 wt. %, for example approximately 0, 0.1, 0.2, 0.3, 0.4, 0.5, 0.6, 0.7, 0.8, 0.9, 1.0, 1.2, 1.2, 1.3, 1.4, 1.5, 1.6, 1.7, 1.8, 1.9 or 2.0 wt. %, based on the total weight of the particular reaction mixture.

Suitable diisocyanates include methylene diphenyl diisocyanate (MDI), toluene-2,4-diisocyanate (TDI), hexamethylene diisocyanate (HDI), polymeric diphenylmethane diisocyanate (PMDI), isophorone diisocyanate (IPDI) and methylene-4,4-bis(cyclohexyl)diisocyanate (H12MD1). Although both aliphatic and aromatic polyisocyanates are taken into consideration, it is preferable for the polyisocyanate to be an aliphatic polyisocyanate. In some embodiments, therefore, the polyisocyanate is an aliphatic diisocyanate. Particularly preferred aliphatic diisocyanates include isophorone diisocyanate, hexamethylene diisocyanate, and mixtures thereof. Suitable polyisocyanates are commercially available, for example, under the trade name Desmodur® from Bayer AG (DE). It is of course also possible to use different compounds (C), i.e., different polyisocyanates, as defined above, together.

A polyol compound (C) is a compound comprising at least two hydroxyl groups, which can in particular be selected from the group consisting of polyester polyols, polyether polyols, polycarbonate polyols, polysiloxane polyols and polyolefin polyols, such as (hydrogenated) polybutadiene polyols.

The polyester polyols include, for example, those which are obtainable by reacting dicarboxylic acids with polyols in a polycondensation reaction. The dicarboxylic acids can be aliphatic, cycloaliphatic or aromatic and/or derivatives thereof such as anhydrides, esters or acid chlorides. Specific examples of these are succinic acid, glutaric acid, adipic acid, pimelic acid, suberic acid, azelaic acid or sebacic acid, phthalic acid, isophthalic acid, trimellitic acid, phthalic anhydride, tetrahydrophthalic anhydride, glutaric anhydride, maleic acid, maleic anhydride, fumaric acid, dimeric fatty acid and dimethyl terephthalate. Examples of suitable polyols are monoethylene glycol, 1,2-propanediol, 1,3-propanediol, 1,4-butanediol, 3-methylpentane-1,5-diol, neopentyl glycol (2,2-dimethyl-1,3-propanediol), 1,6-hexanediol, 1,8-utane glycol cyclohexanedimethanol, 2-methylpropane-1,3-diol, diethylene glycol, triethylene glycol, tetraethylene glycol, polyethylene glycol, dipropylene glycol, polypropylene glycol, polypropylene glycol, dibutylene glycol and polybutylene glycol. Alternatively, they can be obtained by ring-opening polymerization of cyclic esters, preferably ε-caprolactone. Crystalline/semicrystalline polyols, such as esters of 1,4-butanediol with adipic acid, are preferred.

In various embodiments, the polyester polyol has a melting temperature Tm>0° C., preferably >40° C. and/or a number-average molecular weight Mₙ in the range of from 400 to 5,000, preferably 500 to 3,000 g/mol, particularly preferably 800 to 2,500 g/mol, most preferably 1,000 to 2,000 g/mol.

The polyether polyol can be a polyalkylene glycol homo- or copolymer, preferably a polypropylene glycol homo- or copolymer, a polyethylene glycol homo- or copolymer, a polytetramethylene glycol homo- or copolymer or a polypropylene glycol-polyethylene glycol block copolymer.

In various embodiments, the polyether polyol has a number-average molecular weight of 1,000 to 4,000, preferably 1,000 to 3,000 g/mol.

Suitable polycarbonates can be obtained by reacting carbonic acid derivatives, for example diphenyl carbonate, dimethyl carbonate or phosgene, with diols. Suitable examples of such diols are ethylene glycol, 1,2- and 1,3-propanediol, 1,3- and 1,4-butanediol, 1,6-hexanediol, 1,8-octanediol, neopentyl glycol, 1,4-bishydroxymethylcyclohexane, 2-methyl-1,3-propanediol, 2,2,4-trimethylpentanediol-1,3, dipropylene glycol, polypropylene glycols, dibutylene glycol, polybutylene glycols, bisphenol A, tetrabromobisphenol A and lactone-modified diols. The diol component can also have ether or ester groups in addition to the terminal OH groups. The hydroxyl polycarbonates should be substantially linear. However, they can optionally be slightly branched through the incorporation of polyfunctional components, in particular low-molecular-weight polyols. Suitable examples are glycerol, trimethylolpropane, hexanetriol-1,2,6, butanetriol-1,2,4, trimethylolpropane, pentaerythritol, quinitol, mannitol and sorbitol, methyl glycoside, 1,3,4,6-dianhydrohexite. Suitable polycarbonate polyols are, without limitation, those available under the trade names Desmophen® C3200 (Bayer) and Kuraray® C2050 (poly(3-methyl-1,5-pentanediol, 1,6-hexanediol)carbonate; Kuraray).

Amorphous polyols, preferably polyether polyols such as polypropylene glycol or polyTHF, having a number-average molecular weight Mn in the range of from 400 g/mol to 5,000 g/mol, a crystallinity of less than 10% and a glass transition temperature Tg in the range of from −120° C. to 40° C., preferably −70° C. to 30° C., are also suitable, the crystallinity and the glass transition temperature being determined by differential scanning calorimetry (DSC) according to ISO 11357.

The amorphous polyols which can be used according to the embodiments described here are preferably polyether polyols and/or have a number-average molecular weight Mₙ in the range of from 400 g/mol to 5,000 g/mol, preferably 500 to 3,000 g/mol, particularly preferably 800 to 2,500 g/mol, most preferably 1,000 to 2,000 g/mol. “Amorphous,” as used herein in relation to the polyols, means that the polyol has a crystallinity of less than 10%, preferably less than 5%, particularly preferably less than 2%, as determined by differential scanning calorimetry (DSC) according to ISO 11357. In some embodiments, the amorphous (polyether) polyols have a glass transition temperature Tg in the range of from −120° C. to 40° C., preferably −70° C. to 30° C., again determined by differential scanning calorimetry (DSC) according to ISO 11357.

In various embodiments, the reaction mixture also comprises a crystalline or partially crystalline polyol. The crystalline or partially crystalline polyol is preferably a polyester polyol or polycarbonate and can have a number-average molecular weight Mₙ in the range of from 400 g/mol to 5,000 g/mol, preferably 500 to 3,000 g/mol, particularly preferably 800 to 2,500 g/mol, most preferably 1,000 to 2,000 g/mol. “Crystalline,” as used here in relation to the (polyester) polyols, refers to a crystallinity of at least 90%, preferably at least 95%, as determined by differential scanning calorimetry (DSC) according to ISO 11357. Similarly, “semicrystalline,” as used here in relation to the (polyester) polyols, means that said polyols have a crystallinity of at least 50%, preferably at least 70%, but less than 90%. Partially crystalline (polyester) polyols thus comprise crystalline and non-crystalline, i.e., amorphous, regions. The crystalline and partially crystalline (polyester) polyols can have a melting temperature Tm in the range of from 40° C. to 220° C., preferably >40° C. to <160° C., more preferably >40° C. to 80° C., most preferably >40° C. to 60° C., again determined by differential scanning calorimetry (DSC) according to ISO 11357 with a heating rate of 20 K/min. The same procedure can be used for determining the melting enthalpy, the results of the second heating cycle being used for determining the melting enthalpy. In various embodiments, the polyols have melting enthalpies of more than 90 J/g, preferably more than 115 J/g. If no standard reference of the polyol having known crystallinity is available for the determination by means of DSC, known alternative methods, such as X-ray diffractometry, can be used.

Also suitable are low-molecular-weight polyols, such as glycol and derivatives thereof, for example, di- or triethylene glycol, 1,2- or 1,3-propanediol, 1,4-butanediol, 1,5-pentanediol, neopentyl glycol, 1,6-hexanediol, cyclohexanedimethanol and 2,2-bis(4-hydroxycyclohexyl)propane, but also polyhydric alcohols such as trishydroxyalkylalkanes (e.g., trimethylolpropane) or tetrakishydroxyalkylalkanes (e.g., pentaerythritol).

Also suitable are polyols which are hydroxy-functionalized polymers, for example hydroxy-functionalized siloxanes. Hydroxy-functionalized polydimethylsiloxanes, in particular in liquid form, as are commercially available under the name Tegomer® H-Si 2311 (Evonik, Germany) having a molecular weight Mn of ca. 2,200 g/mol, can be used as siloxanes. Suitable polydimethylsiloxane (PDMS) polyols are described, for example, in U.S. Pat. No. 6,794,445 B2.

Polyolefin polyols are derived, for example, from oligomeric and polymeric olefins having at least two terminal hydroxyl groups. Alpha, omega-dihydroxy polybutadiene is preferred as a non-limiting example.

In both variants of the preparation of a dispersion of a cationically modified polyurethane, i.e., either by dispersing a cationically modified polyurethane in an aqueous phase, the corresponding cationically modified polyurethane being obtainable by cross-linking a cationically modified polyurethane prepolymer, obtainable as defined above, or by a preparation method comprising the above steps a)-c), the reaction of at least one compound (A), at least one compound (B) and optionally at least one compound (C), as defined above, can take place according to some embodiments in the presence of at least one catalyst.

Suitable catalysts are known in the prior art and include, for example but without limitation, catalysts based on tin, bismuth or zinc, for example dibutyltin dilaurate or dimethylbis[(1-oxoneodecyl)oxy]stannane, for example commercially available under the trade name Fomrez UL28 (Momentive Performance Materials GmbH, Germany). Alternative catalysts having a high level of reactivity are bismuth neodecanoate and Zn neodecanoate, which are available under the trade names BorchiKat 315 and BorchiKat 0761 (OMG Borchers GmbH, Germany). Usual amounts of catalyst are in the range of from approximately 0.001 to 5 wt. %, preferably in the range of from approximately 0.01 to approximately 2 wt. %, for example approximately 0.01, 0.02, 0.05, 0.09, 0.1, 0.2, 0.3, 0.4, 0.5, 0.6, 0.7, 0.8, 0.9, 1.0, 1.5 or 2.0 wt. %, in each case based on the total weight of the reaction mixture of polyol and isocyanate components.

The polyisocyanate is usually used in a molar excess in relation to the OH groups of all polyols present, i.e., the at least one compound (A) and optionally the at least one compound (C), with the OH/NCO equivalent ratio preferably being 1:1.1 to 1:4, more preferably 1:1.2 to 1:1.3. The amount of the at least one polyisocyanate in the reaction mixture for preparing the prepolymer is typically in the range of from 10 to 20 wt. %, based on the reaction mixture. The remainder of the reaction mixture can consist of the polyol component or components as defined above.

In various embodiments, it can be advantageous to heat a particular polyol (mixture). Heating may be necessary if the polyols used are solid at room temperature and have to be melted to form a usable/handleable polyol component. In some embodiments, the at least one compound (A) and the optional at least one compound (C) are combined and heated to approximately 70 to 95° C., for example approximately 75° C., while the mixture is stirred under vacuum to dry. After mixing, the mixture can be cooled to approximately 60° C. for the addition of the isocyanates.

The polyol mixture is then combined with at least one polyisocyanate (B) in the reaction mixture to form the prepolymer. The prepolymer reaction generally takes place at an elevated temperature, for example in the range between approximately 70° C. and approximately 95° C., particularly preferably at approximately 80° C., over a period of approximately 1 to approximately 24 hours.

Correspondingly, in various embodiments, step b) takes place at elevated temperatures in the range of from approximately 27 to approximately 95° C., preferably approximately 50 to approximately 90° C.

The reaction is continued until the content of free isocyanate reaches or comes very close to the calculated value as determined by standard titration with dibutylamine. Preferred values for the content of free isocyanate in the prepolymer are in the range between 0.2 and 3 wt. %, preferably 1 to 2 wt. %, based on the total weight of the reaction mixture.

As described above, the polyisocyanate is reacted in the polyurethane prepolymer formation reaction in a concentration which is above the stoichiometric concentration required for complete reaction with the hydroxyl groups. The excess used can comprise an OH/NCO equivalent ratio of 1:1.1 to 1:4. Preferably, the amount of polyisocyanate should be 20% to 150% above the stoichiometric concentration required for the complete reaction with the hydroxyl groups.

The cationically modified polyurethane prepolymer obtained in this way is then dispersed in an aqueous phase (step b). In order to facilitate the conversion and dispersion of the prepolymer, it may be desirable to dissolve the prepolymer beforehand in a suitable solvent, preferably a highly volatile solvent which is miscible with water. The prepolymer is preferably dispersed by adding the prepolymer to the aqueous phase with stirring. The hardness of the water used is not important for the method, and therefore the use of distilled or desalinated water is not absolutely necessary. The dispersion according to step b) is preferably carried out at a temperature of from approximately 27 to 95° C., in particular approximately 30 to 90° C., more preferably approximately 40 to 80° C. This can mean that the aqueous phase is heated before the addition of the prepolymer and/or that the mixture of the two phases is heated, for example while stirring. The stirring is preferably carried out over a period of from approximately 1 minute to approximately 60 minutes, for example approximately 1, 2, 3, 4, 5, 6, 7, 8, 9, 10, 11, 12, 13, 14, 15, 20 25, 30, 35, 40, 45, 50, 55 or 60 minutes, preferably using a suitable stirring or mixing device, for example a magnetic stirrer or a static mixer.

The resulting dispersion of the cationically modified polyurethane prepolymer is then chain-extended in order to obtain a dispersion of a cationically modified polyurethane polymer. Chain extenders that are suitable for this purpose are known in the prior art and include, but are not limited to, inorganic or organic polyamines having an average of approximately 2 or more primary and/or secondary amine groups, or combinations thereof.

Suitable organic amines include diamines and polyamines, for example, but not limited to, ethylenediamine (EDA), diethylenetriamine (DETA), triethylenetetramine (TETA), meta-xylylenediamine (MXDA), aminoethylethanolamine (AEEA), 2-methylpentanediamine, and the like. Mixtures thereof are also suitable. Propylenediamine, butylenediamine, hexamethylenediamine, cyclohexylenediamine, phenylenediamine, tolylenediamine, 3,3-dichlorobenzide, 4,4′-methylene-bis-(2-chloroaniline), 3,3-dichloro-4,4-diaminodiphenylmethane, sulfonated primary and/or secondary amines and the like, as well as mixtures thereof, are also suitable.

Suitable inorganic amines include hydrazine, substituted hydrazines and hydrazine reaction products, and the like, as well as mixtures thereof.

Overall, preferred in this context are adipic acid dihydrazide, ethylenediamine, diethylenetriamine, triethylenetetraamine, tetraethylenepentamine, pentaethylenehexamine, dipropylenetriamine, hexamethylenediamine, hydrazine, isophoronediamine, N-(2-aminoethyl adducts)-acrylamido-2-methylpropane-1-sulfonic acid (AMPSO) and ethylenediamine, adduct salts of (meth)acrylic acid and ethylenediamine, adducts of 1,3-propanesulfone and ethylenediamine, or any combination of these polyamines. Bifunctional primary amines, in particular ethylenediamine, are preferably used.

However, since water can in principle also function as a chain extender, the use of one of the above-mentioned amine-based chain extenders is not absolutely necessary.

The amount of chain extender used, water not being understood as such in this context, is, in various embodiments, approximately 0 to 20 wt. %, preferably approximately 0 to 15 wt. %, for example approximately 0, 0.1, 0.5, 1.0, 1.5, 2.0, 3.0, 4.0, 5.0, 6.0, 7.0, 8.0, 9.0, 10.0, 11.0, 12.0, 13.0, 14.0 or 15.0 wt. %, based on the total weight of the polyurethane prepolymer.

The reaction is continued until the content of free isocyanate reaches or comes very close to the calculated value as determined by standard titration with dibutylamine. Preferred values for the content of free isocyanate in the prepolymer are in the range between 0.2 and 3 wt. %, preferably 1 to 2 wt. %, based on the total weight of the reaction mixture.

Any solvents and/or acids (introduced in the form of salts of compound (A)) that are present can then be removed under vacuum.

In various embodiments, the amount of cationic component, i.e., the amount of compound (A), in the polyurethane polymer is approximately 1 to 20 wt. %, for example approximately 1, 2, 3, 4, 5, 6, 7, 8, 9, 10, 11, 12, 13, 14, 15, 16, 17, 18, 19 or 20 wt. %, preferably approximately 1 to 8 wt. %, for example approximately 1.5, 2.5, 3.5, 4.5, 6.5, 7.5 wt. %, in each case based on the total weight of the final polymer.

In various embodiments, the number of —(Y)ₙ—H groups, as defined above, can be 0.1 to approximately 20 milliequivalents per gram of urethane polymer.

In various embodiments, the at least one cationically modified polyurethane is contained in the dispersion in an amount of from approximately 1 to 50 wt. %, for example approximately 1, 2, 3, 4, 5, 6, 7, 8, 9, 10, 11, 12, 13, 14, 15, 20, 25, 30, 35, 40, 45 or 50 wt. %, preferably approximately 10 to 25 wt. %, for example approximately 10, 16, 17, 18, 19, 20, 21, 22, 23, 24 or 25 wt. %, in each case based on the total weight of the dispersion.

In various embodiments, the dispersion of at least one cationically modified polyurethane has a viscosity of approximately 100 to 1,000 mPas, for example 100, 150, 200, 500, 700, 750, 800, 850, 900, 950 or 1,000 mPas, preferably approximately 200 to 600 mPas, for example approximately 100, 150, 300, 350, 400, 450, 500, 550 or 600 mPas.

As has already been mentioned, it has surprisingly been found that dispersions of cationically modified polyurethanes, as described above, demonstrate a softening effect on textile fibers, in particular on cotton fibers, when they are brought into contact with laundry in the course of a rinsing process after the actual washing step. In order to be able to achieve such an effect, even low concentrations of such a dispersion are sufficient. A dispersion, as defined and described above, of at least one cationically modified polyurethane can be brought into contact with the laundry to be treated/conditioned either as a constituent of a textile treatment agent, for example of a fabric softener, or in pure form, i.e., not as a constituent of a textile treatment agent.

If a dispersion as described herein of at least one cationically modified polyurethane polymer is used in pure form, it is sufficient if the dispersed, cationically modified polyurethane is contained in an amount of from approximately 1 to 50 wt. %, for example approximately 1, 2, 3, 4, 5, 6, 7, 8, 9, 10, 11, 12, 13, 14, 15, 20, 25, 30, 35, 40, 45 or 50 wt. %, preferably approximately 10 to 25 wt. %, for example approximately 10, 16, 17, 18, 19, 20, 21, 22, 23, 24 or 25 wt. %, in each case based on the total weight of the dispersion.

Advantageous use amounts of a dispersion as described above are in the range of from approximately 0.5 to 50 ml, preferably in the range of from approximately 1 to 50 ml, for example approximately 1, 2, 3, 4, 5, 6, 7, 8, 9, 0, 11, 12, 13, 14, 15, 16, 17, 18, 19, 20, 25, 30, 35, 40, 45 or 50 ml, more preferably in the range of from approximately 3 to 30 ml. The aforementioned amounts relate to the amount of dispersion that is sufficient for treating/conditioning a normal laundry load of ca. 1-5 kg and accordingly placed in the fabric softener chamber of a washing machine or used in the course of a manual washing process following the actual laundry cleaning operation using a washing agent.

However, since the advantageous effect of a dispersion, as described herein, of at least one cationically modified polyurethane also becomes apparent when such a dispersion is used as a constituent of a textile treatment agent, such as a textile treatment agent comprising at least one dispersion of at least one cationically modified polyurethane as defined and described herein. In various embodiments, such a textile treatment agent is a fabric softener. However, other types of textile treatment agents, such as textile sprays, for example ironing sprays, and the like, are also envisaged.

If a dispersion, as described herein, of at least one cationically modified polyurethane, or a mixture of several such dispersions, is a constituent of a textile treatment agent, for example a fabric softener, it is preferably contained in said agent in an amount of from approximately 5 to 25 wt. %, more preferably in an amount of from approximately 6 to 15 wt. %, for example in an amount of approximately 6, 7, 8, 9, 10, 11, 12, 13, 14 or 15 wt. %, in each case based on the total weight of the agent.

In addition to the at least one dispersion of at least one cationically modified polyurethane polymer, the agents can contain further ingredients, for example at least one further constituent, preferably at least two further constituents, which further improve the practical and/or aesthetic properties of the agent. These include, for example, in particular other softening compounds, fragrances, surfactants, thickeners, emulsifiers, hydrotropic substances, non-aqueous solvents, electrolytes, pH adjusters, perfume carriers, fluorescent agents, dyes, foam inhibitors, anti-redeposition agents, enzymes, optical brighteners, graying inhibitors, anti-shrink agents, anti-crease agents, dye transfer inhibitors, antimicrobial active ingredients, germicides, fungicides, antioxidants, corrosion inhibitors, antistatic agents, ironing aids, repellents and impregnating agents, anti-swelling and anti-slip agents, and UV absorbers. An agent can of course comprise one or, preferably, more of these auxiliaries.

A “softening compound” within the meaning of the present disclosure is a compound that is able to soften textile fabrics or to present this impression to the consumer. This designation also includes a dispersion of at least one cationically modified polyurethane, as described above. In various embodiments, however, it is provided that at least one further softening compound, i.e., a softening compound which is used in addition to, in other words in combination with, the at least one dispersion of at least one cationically modified polyurethane, as defined herein, is preferably selected from the group of quaternary ammonium compounds, in particular selected from the group of esterquats.

The term “esterquat,” as used herein, refers to esters of quaternary ammonium polyols, in particular quaternary ammonium diols and/or triols, such as triethanol methyl ammonium or diethanol dimethyl ammonium, with fatty acids.

In general, the use of esterquats in cosmetic products, washing and after-treatment agents, in particular in fabric softeners, is known in the prior art. These contribute to improving the softness, reducing the static charge on the textile fabrics and reducing the drying time.

In various embodiments, the textile treatment agent contains at least one esterquat of formula (I) N⁺(R¹)₄₋ₙ((CH₂)ₘ—O—C(O)—R²)ₙX—, wherein (I) each R¹ is, independently of one another, a substituted or unsubstituted, linear or branched alkyl or alkenyl, preferably an unsubstituted or hydroxy-substituted alkyl having 1 to 10 carbon atoms; each R² is a linear or branched, substituted or unsubstituted alkyl or alkenyl or a substituted or unsubstituted (hetero)aryl having up to 26 carbon atoms, preferably linear unsubstituted C₁₀₋₂₆ alkyl; n is 1, 2, 3 or 4, preferably 1, 2 or 3; m is an integer from 1 to 20, preferably 1 to 4; and X⁻ is any anion.

In various embodiments, in the compounds of formula (I)

(i) n is 2 or 3, preferably 2; and/or
(ii) m is 1, 2, 3 or 4, preferably 2; and/or
(iii) each R¹ is, independently from one another, selected from the group consisting of methyl, ethyl, n-propyl, iso-propyl, n-butyl, iso-butyl, hydroxymethyl, 2-hydroxyethyl, 2-hydroxypropyl and 3-hydroxypropyl, preferably a first R¹ is selected from methyl, ethyl, n-propyl, iso-propyl, n-butyl and iso-butyl and a second R¹ is selected from methyl, ethyl, n-propyl, iso-propyl, n-butyl, iso-butyl, hydroxymethyl, 2-hydroxyethyl, 2-hydroxypropyl and 3-hydroxypropyl; and/or
(iv) each R² is, independently from one another, selected from linear, unsubstituted C₁₂₋₂₀ alkyl, preferably C₁₂₋₁₈ alkyl; and/or
(v) X⁻ is selected from inorganic or organic anions, in particular fluoride, chloride, bromide and methosulfate.

In a particularly preferred embodiment, the esterquat used is an esterquat of formula (I), where n=2 and m=2, the first R¹ is selected from methyl and ethyl, preferably methyl, and the second R¹ is selected from methyl and 2-hydroxyethyl, preferably 2-hydroxyethyl, and each R² is linear, unsubstituted C₁₂₋₁₈ alkyl. Such esterquats are bis(acyloxyethyl)hydroxyethyl methylammonium compounds. The counterion is preferably methosulfate. Such esterquats are commercially available under the trade name Dehyquart® AU-57 (BASF SE, DE), for example.

In various embodiments, the textile treatment agent contains, based on the total weight of the agent, at least 4 wt. % of at least one further softening compound, as defined above, in particular at least one compound of formula (I), for example in amounts of up to 60 wt. %, preferably up to 30 wt. %, in each case based on the total weight of the textile treatment agent.

In various embodiments, an agent comprises at least one fragrance.

As fragrances, odorants or perfume oils, all substances and mixtures known for this purpose can be used. As used herein, the terms “odorant(s),” “fragrances” and “perfume oil(s)” are used synonymously. The terms refer, in particular, to all substances or mixtures thereof that are perceived by humans and animals as having a smell, in particular perceived by humans as having a pleasant smell.

Perfumes, perfume oils, or perfume oil constituents may be used as fragrance components. Perfume oils or fragrances may be individual odorant compounds, such as synthetic products of the ester, ether, aldehyde, ketone, alcohol, and hydrocarbon types.

Fragrance compounds of the aldehyde type are, for example, adoxal (2,6,10-trimethyl-9-undecenal), anisaldehyde (4-methoxybenzaldehyde), cymene (3-(4-isopropyl-phenyl)-2-methylpropanal), ethyl vanillin, Florhydral (3-(3-isopropylphenyl)butanal), Helional (3-(3,4-methylenedioxyphenyl)-2-methylpropanal), heliotropin, hydroxycitronellal, lauraldehyde, Lyral (3- and 4-(4-hydroxy-4-methylpentyl)-3-cyclohexene-1-carboxaldehyde), methylnonylacetaldehyde, lilial (3-(4-tert-butylphenyl)-2-methylpropanal), phenylacetaldehyde, undecylenealdehyde, vanillin, 2,6,10-trimethyl-9-undecenal, 3-dodecen-1-al, alpha-n-amylcinnamaldehyde, melonal (2,6-dimethyl-5-heptenal), 2,4-di-methyl-3-cyclohexene-1-carboxaldehyde (Triplal), 4-methoxybenzaldehyde, benzaldehyde, 3-(4-tert-butylphenyl)-propanal, 2-methyl-3-(para-methoxyphenyl)propanal, 2-methyl-4-(2,6,6-timethyl-2(1)-cyclohexen-1-yl)butanal, 3-phenyl-2-propenal, cis-/trans-3,7-dimethyl-2,6-octadien-1-al, 3,7-dimethyl-6-octen-1-al, [(3,7-dimethyl-6-octenyl)oxy]acetaldehyde, 4-isopropylbenzylaldehyde, 1,2,3,4,5,6,7,8-octahydro-8,8-dimethyl-2-naphthaldehyde, 2,4-dimethyl-3-cyclohexene-1-carboxaldehyde, 2-methyl-3-(isopropylphenyl)propanal, 1-decanal, 2,6-dimethyl-5-heptenal, 4-(tricyclo[5.2.1.0(2,6)]-decylidene-8)-butanal, octahydro-4,7-methane-1H-indenecarboxaldehyde, 3-ethoxy-4-hydroxybenzaldehyde, para-ethyl-alpha,alpha-dimethylhydrocinnamaldehyde, alpha-methyl-3,4-(methylenedioxy)-hydrocinnamaldehyde, 3,4-methylenedioxybenzaldehyde, alpha-n-hexylcinnamaldehyde, m-cymene-7-carboxaldehyde, alpha-methylphenylacetaldehyde, 7-hydroxy-3,7-dimethyloctanal, undecenal, 2,4,6-trimethyl-3-cyclohexene-1-carboxaldehyde, 4-(3)(4-methyl-3-pentenyl)-3-cyclohexene carboxaldehyde, 1-dodecanal, 2,4-dimethylcyclohexene-3-carboxaldehyde, 4-(4-hydroxy-4-methylpentyl)-3-cyclohexene-1-carboxaldehyde, 7-methoxy-3,7-dimethyloctan-1-al, 2-methyl-undecanal, 2-methyldecanal, 1-nonanal, 1-octanal, 2,6,10-trimethyl-5,9-undecadienal, 2-methyl-3-(4-tert-butyl)propanal, dihydrocinnamaldehyde, 1-methyl-4-(4-methyl-3-pentenyI)-3-cyclohexene-1-carboxaldehyde, 5- or 6-methoxyhexahydro-4,7-methanindan-1- or 2-carboxaldehyde, 3,7-dimethyloctan-1-al, 1-undecanal, 10-undecen-1-al, 4-hydroxy-3-methoxybenzaldehyde, 1-methyl-3-(4-methylpentyl)-3-cyclohexenecarboxaldehyde, 7-hydroxy-3J-dimethyl-octanal, trans-4-decenal, 2,6-nonadienal, para-tolylacetaldehyde, 4-methylphenylacetaldehyde, 2-methyl-4-(2,6,6-trimethyl-1-cyclohexen-1-yl)-2-butenal, ortho-methoxycinnamaldehyde, 3,5,6-trimethyl-3-cyclohexene-carboxaldehyde, 3J-dimethyl-2-methylene-6-octenal, phenoxyacetaldehyde, 5,9-dimethyl-4,8-decadienal, peony aldehyde (6,10-dimethyl-3-oxa-5,9-undecadien-1-al), hexahydro-4,7-methanindan-1-carboxaldehyde, 2-methyloctanal, alpha-methyl-4-(1-methylethyl)benzeneacetaldehyde, 6,6-dimethyl-2-norpinene-2-propionaldehyde, para-methylphenoxyacetaldehyde, 2-methyl-3-phenyl-2-propen-1-al, 3,5,5-trimethylhexanal, hexahydro-8,8-dimethyl-2-naphthaldehyde, 3-propyl-bicyclo-[2.2.1]-hept-5-ene-2-carbaldehyde, 9-decenal, 3-methyl-5-phenyl-1-pentanal, methylnonylacetaldehyde, hexanal and trans-2-hexenal.

Fragrance compounds of the ketone type are, for example, methyl-beta-naphthyl ketone, musk indanone (1,2,3,5,6,7-hexahydro-1,1,2,3,3-pentamethyl-4H-inden-4-one), tonalide (6-acetyl-1,1,2,4,4,7-hexamethyltetralin), alpha-damascone, beta-damascone, delta-damascone, iso-damascone, damascenone, methyldihydrojasmonate, menthone, carvone, camphor, Koavone (3,4,5,6,6-pentamethylhept-3-en-2-one), fenchone, alpha-ionone, beta-ionone, gamma-methyl-ionone, fleuramone (2-heptylcyclopentanone), dihydrojasmone, cis-jasmone, Iso E Super (1-(1,2,3,4,5,6J,8-octahydro-2,3,8,8-tetramethyl-2-naphthalenyl)-ethan-1-one (and isomers)), methyl cedrenyl ketone, acetophenone, methyl acetophenone, para-methoxy acetophenone, methyl beta-naphthyl ketone, benzyl acetone, benzophenone, para-hydroxyphenyl butanone, celery ketone (3-methyl-5-propyl-2-cyclohexenone), 6-isopropyldecahydro-2-naphthone, dimethyloctenone, frescomenthe (2-butan-2-yl-cyclohexan-1-one), 4-(1-ethoxyvinyl)-3,3,5,5-tetramethylcyclohexanone, methylheptenone, 2-(2-(4-methyl-3-cyclohexen-1-yl)propyl)cyclopentanone, 1-(p-menthen-6(2)-yl)-1-propanone, 4-(4-hydroxy-3-methoxyphenyl)-2-butanone, 2-acetyl-3,3-dimethylnorbornane, 6,7-dihydro-1,1,2,3,3-pentamethyl-4(5H)-indanone, 4-damascol, Dulcinyl (4-(1,3-benzodioxol-5-yl)butan-2-one), Hexalone (1-(2,6,6-trimethyl-2-cyclohexen-1-yl)-1,6-heptadien-3-one), Isocyclemone E (2-acetonaphthone-1,2,3,4,5,6,7,8-octahydro-2,3,8,8-tetramethyl), methyl nonylketone, methylcyclocitrone, methyl lavender ketone, Orivone (4-tert-amyl-cyclohexanone), 4-tert-butylcyclohexanone, Delphone (2-pentyl-cyclopentanone), muscone (CAS 541-91-3), Neobutenone (1-(5,5-dimethyl-1-cyclohexenyl)pent-4-en-1-one), plicatone (CAS 41724-19-0), Veloutone (2,2,5-trimethyl-5-pentylcyclopentan-1-one), 2,4,4,7-tetramethyl-oct-6-en-3-one and tetramerane (6,10-dimethylundecen-2-one).

Fragrance compounds of the alcohol type are, for example, 10-undecen-1-ol, 2,6-dimethylheptan-2-ol, 2-methylbutanol, 2-methylpentanol, 2-phenoxyethanol, 2-phenylpropanol, 2-tert-butycyclohexanol, 3,5,5-trimethylcyclohexanol, 3-hexanol, 3-methyl-5-phenylpentanol, 3-octanol, 3-phenyl-propanol, 4-heptenol, 4-isopropylcyclohexanol, 4-tert-butycyclohexanol, 6,8-dimethyl-2-nonanol, 6-nonen-1-ol, 9-decen-1-ol, α-methylbenzyl alcohol, α-terpineol, amyl salicylate, benzyl alcohol, benzyl salicylate, β-terpineol, butyl salicylate, citronellol, cyclohexyl salicylate, decanol, dihydromyrcenol, dimethyl benzyl carbinol, dimethyl heptanol, dimethyl octanol, ethyl salicylate, ethyl vanillin, eugenol, farnesol, geraniol, heptanol, hexyl salicylate, isoborneol, isoeugenol, isopulegol, linalool, menthol, myrtenol, n-hexanol, nerol, nonanol, octanol, p-menthan-7-01, phenylethyl alcohol, phenol, phenyl salicylate, tetrahydrogeraniol, tetrahydrolinalool, thymol, trans-2-cis-6-nonadicnol, trans-2-nonen-1-ol, trans-2-octenol, undecanol, vanillin, champiniol, hexenol and cinnamyl alcohol.

Fragrance compounds of the ester type are e.g., benzyl acetate, phenoxyethyl isobutyrate, p-tert-butylcyclohexyl acetate, linalyl acetate, dimethylbenzylcarbinyl acetate (DMBCA), phenylethyl acetate, benzyl acetate, ethylmethylphenyl glycinate, allylcyclohexyl propionate, styrallyl propionate, benzyl salicylate, cyclohexyl salicylate, floramate, melusate, and jasmacyclate.

Ethers include, for example, benzyl ethyl ether and Ambroxan. Hydrocarbons mainly include terpenes such as limonene and pinene.

Preferably, mixtures of different fragrances are used, which together produce an appealing fragrance note. Such a mixture of fragrances may also be referred to as perfume or perfume oil. Perfume oils of this kind may also contain natural fragrance mixtures, such as those obtainable from plant sources.

Fragrances of plant origin include essential oils such as angelica root oil, aniseed oil, arnica blossom oil, basil oil, bay oil, champaca blossom oil, citrus oil, abies alba oil, abies alba cone oil, elemi oil, eucalyptus oil, fennel oil, spruce needle oil, galbanum oil, geranium oil, ginger grass oil, guaiac wood oil, gurjun balsam oil, helichrysum oil, ho oil, ginger oil, iris oil, jasmine oil, cajeput oil, calamus oil, chamomile oil, camphor oil, cananga oil, cardamom oil, cassia oil, pine needle oil, copaiba balsam oil, coriander oil, spearmint oil, caraway oil, cumin oil, labdanum oil, lavender oil, lemon grass oil, lime blossom oil, lime oil, mandarin oil, melissa oil, mint oil, musk seed oil, muscatel oil, myrrh oil, clove oil, neroli oil, niaouli oil, olibanum oil, orange blossom oil, orange peel oil, oregano oil, palmarosa oil, patchouli oil, balsam Peru oil, petitgrain oil, pepper oil, peppermint oil, allspice oil, pine oil, rose oil, rosemary oil, sage oil, sandalwood oil, celery oil, spike (lavender) oil, star anise oil, turpentine oil, thuja oil, thyme oil, verbena oil, vetiver oil, juniper berry oil, wormwood oil, wintergreen oil, ylang-ylang oil, hyssop oil, cinnamon oil, cinnamon leaf oil, citronella oil, lemon oil and cypress oil, and ambrettolide, Ambroxan, alpha-amylcinnamaldehyde, anethole, anisaldehyde, anise alcohol, anisole, anthranilic acid methyl ester, acetophenone, benzylacetone, benzaldehyde, benzoic acid ethyl ester, benzophenone, benzyl alcohol, benzyl acetate, benzyl benzoate, benzyl formate, benzyl valerianate, borneol, bornyl acetate, boisambrene forte, alpha-bromostyrene, n-decyl aldehyde, n-dodecyl aldehyde, eugenol, eugenol methyl ether, eucalyptol, farnesol, fenchone, fenchyl acetate, geranyl acetate, geranyl formate, heliotropin, heptyne carboxylic acid methyl ester, heptaldehyde, hydroquinone dimethyl ether, hydroxycinnamaldehyde, hydroxycinnamyl alcohol, indole, irone, isoeugenol, isoeugenol methyl ether, isosafrole, jasmone, camphor, carvacrol, carvone, p-cresol methyl ether, coumarin, p-methoxyacetophenone, methyl n-amyl ketone, methylanthranilic acid methyl ester, p-methylacetophenone, methyl chavicol, p-methylquinoline, methyl beta-naphthyl ketone, methyl n-nonyl acetaldehyde, methyl n-nonyl ketone, muscone, beta-naphthol ethyl ether, beta-naphthol methyl ether, nerol, n-nonyl aldehyde, nonyl alcohol, n-octyl aldehyde, p-oxy-acetophenone, pentadecanolide, beta-phenethyl alcohol, phenylacetic acid, pulegone, safrole, salicylic acid isoamyl ester, salicylic acid methyl ester, salicylic acid hexyl ester, salicylic acid cyclohexyl ester, santalol, sandelice, skatole, terpineol, thymene, thymol, troenan, gamma-undecalactone, vanillin, veratraldehyde, cinnamaldehyde, cinnamyl alcohol, cinnamic acid, cinnamic acid ethyl ester, cinnamic acid benzyl ester, diphenyl oxide, limonene, linalool, linalyl acetate and propionate, melusate, menthol, menthone, methyl-n-heptenone, pinene, phenylacetaldehyde, terpinyl acetate, citral, citronellal and mixtures thereof.

Mixtures of said substances may also be used.

If it is to be perceptible, an odorant must be volatile, and, in addition to the nature of the functional groups and the structure of the chemical compound, the molar mass also plays an important role. Therefore, most odorants have molar masses of up to approximately 200 daltons, while molar masses of 300 daltons and above are something of an exception. Due to the differing volatility of odorants, the odor of a perfume or fragrance composed of multiple odorants varies over the course of evaporation, the odor impressions being divided into “top note,” “middle note or body” and “end note or dry out.” Analogously to the description in the international patent publication WO 2016/200761 A2, the top, middle and end notes can be classified on the basis of their vapor pressure (determinable by means of the test methods described in WO 2016/200761) as follows:

Top notes: vapor pressure at 25° C.: >0.0133 kPa
Middle notes: vapor pressure at 25° C.: 0.0133 to 0.000133 kPa
End notes: vapor pressure at 25° C.: <0.000133 kPa

Examples of adherent odorants that can be used are essential oils such as angelica root oil, aniseed oil, arnica blossom oil, basil oil, bay oil, bergamot oil, champaca blossom oil, abies alba oil, abies alba cone oil, elemi oil, eucalyptus oil, fennel oil, spruce needle oil, galbanum oil, geranium oil, ginger grass oil, guaiac wood oil, gurjun balsam oil, helichrysum oil, ho oil, ginger oil, iris oil, cajeput oil, calamus oil, chamomile oil, camphor oil, cananga oil, cardamom oil, cassia oil, pine needle oil, copaiba balsam oil, coriander oil, spearmint oil, caraway oil, cumin oil, lavender oil, lemon grass oil, lime oil, mandarin oil, melissa oil, musk seed oil, myrrh oil, clove oil, neroli oil, niaouli oil, olibanum oil, orange oil, oregano oil, palmarosa oil, patchouli oil, balsam Peru oil, petitgrain oil, pepper oil, peppermint oil, allspice oil, pine oil, rose oil, rosemary oil, sandalwood oil, celery oil, spike (lavender) oil, star anise oil, turpentine oil, thuja oil, thyme oil, verbena oil, vetiver oil, juniper berry oil, wormwood oil, wintergreen oil, ylang-ylang oil, hyssop oil, cinnamon oil, cinnamon leaf oil, citronella oil, lemon oil, and cypress oil.

Higher-boiling or solid odorants of natural or synthetic origin include, for example: ambrettolide, α-amylcinnamaldehyde, anethole, anisaldehyde, anise alcohol, anisole, anthranilic acid methyl ester, acetophenone, benzylacetone, benzaldehyde, benzoic acid ethyl ester, benzophenone, benzyl alcohol, benzyl acetate, benzyl benzoate, benzyl formate, benzyl valerianate, borneol, bornyl acetate, α-bromostyrene, n-decyl aldehyde, n-dodecyl aldehyde, eugenol, eugenol methyl ether, eucalyptol, farnesol, fenchone, fenchyl acetate, geranyl acetate, geranyl formate, heliotropin, heptyne carboxylic acid methyl ester, heptaldehyde, hydroquinone dimethyl ether, hydroxycinnamaldehyde, hydroxycinnamyl alcohol, indole, irone, isoeugenol, isoeugenol methyl ether, isosafrole, jasmone, camphor, carvacrol, carvone, p-cresol methyl ether, coumarin, p-methoxyacetophenone, methyl n-amyl ketone, methylanthranilic acid methyl ester, p-methylacetophenone, methylchavicol, p-methylquinoline, methyl-β-naphthyl ketone, methyl n-nonyl acetaldehyde, methyl n-nonyl ketone, muscone, β-naphthol ethyl ether, β-naphthol methyl ether, nerol, nitrobenzene, n-nonyl aldehyde, nonyl alcohol, n-octyl aldehyde, p-oxyacetophenone, pentadecanolide, β-phenethyl alcohol, phenylacetaldehyde dimethyl acetal, phenylacetic acid, pulegone, safrole, salicylic acid isoamyl ester, salicylic acid methyl ester, salicylic acid hexyl ester, salicylic acid cyclohexyl ester, santalol, skatole, terpineol, thymene, thymol, γ-undecalactone, vanillin, veratraldehyde, cinnamaldehyde, cinnamyl alcohol, cinnamic acid, cinnamic acid ethyl ester and cinnamic acid benzyl ester.

More volatile odorants include in particular lower-boiling odorants of natural or synthetic origin, which may be used alone or in mixtures. Examples of more volatile odorants are alkyl isothiocyanates (alkyl mustard oils), butanedione, limonene, linalool, linayl acetate and propionate, menthol, menthone, methyl-n-heptenone, phellandrene, phenylacetaldehyde, terpinyl acetate, citral and citronellal.

Odorant compounds of the aldehyde type that can preferably be used are hydroxycitronellal (CAS 107-75-5), helional (CAS 1205-17-0), citral (5392-40-5), bourgeonal (18127-01-0), Triplal (CAS 27939-60-2), ligustral (CAS 68039-48-5), vertocitral (CAS 68039-49-6), Florhydral (CAS 125109-85-5), citronellal (CAS 106-23-0), and citronellyl oxyacetaldehyde (CAS 7492-67-3).

In addition to or as an alternative to the above-mentioned odorants, it is also possible to use the odorants described in WO 2016/200761 A2, in particular the odorants mentioned in Tables 1, 2 and 3, and the modulators listed in Tables 4a and 4b. The whole of this publication is incorporated herein by way of reference.

A perfume oil can also be contained in the form of a perfume oil preparation and for example comprise at least one further active substance in oil form. Suitable active substances in oil form in this context are those which are suitable for washing, cleaning, care and/or finishing purposes, in particular

(a) textile care substances, such as preferably silicone oils, and/or
(b) skin care substances, such as preferably vitamin E, natural oils and/or cosmetic oils.

Skin care active substances are all those active substances which give the skin a sensory and/or cosmetic advantage. Skin care active substances are preferably selected from the following substances:
a) waxes such as carnauba, spermaceti, beeswax, lanolin and/or derivatives thereof and others
b) hydrophobic plant extracts
c) hydrocarbons such as squalene and/or squalane
d) higher fatty acids, preferably those having at least 12 carbon atoms, for example lauric acid, stearic acid, behenic acid, myristic acid, palmitic acid, oleic acid, linoleic acid, linolenic acid, isostearic acid and/or polyunsaturated fatty acids and others
e) higher fatty alcohols, preferably those having at least 12 carbon atoms, for example lauryl alcohol, cetyl alcohol, stearyl alcohol, oleyl alcohol, behenyl alcohol, cholesterol and/or 2-hexadecanol and others
f) esters, preferably such as cetyloctanoate, lauryl lactate, myristyl lactate, cetyl lactate, isopropyl myristate, myristyl myristate, isopropyl palmitate, isopropyl adipate, butyl stearate, decyl oleate, cholesteryl isostearate, glycerol monostearate, glyceryl distearate, glycerol tristearate, alkyl lactate, alkyl citrate and/or alkyl tartrate and others
g) lipids such as cholesterol, ceramides and/or sucrose esters and others
h) vitamins such as vitamins A, C and E, vitamin alkyl esters, including vitamin C alkyl esters and others
i) sunscreens
j) phospholipids
k) derivatives of alpha hydroxy acids
l) germicides for cosmetic use, both synthetic such as salicylic acid and/or others and natural such as neem oil and/or others
m) silicones
n) natural oils, e.g., almond oil
   and mixtures of any of the components listed above.

In various embodiments, the content of such a fragrance, which can also be present in the form of a perfume oil or as a constituent of a perfume oil composition, as described above, is preferably between approximately 0.0001 and 5 wt. %, in particular between approximately 0.001 and 3.0 wt. % %, preferably between approximately 0.005 and 1.5 wt. %, more preferably between approximately 0.01 and 1.0 wt. %, for example approximately 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9 or 1.0 wt. %, in each case based on the total weight of the agent.

It may be desirable to keep sensitive benefit agents/active ingredients, such as perfumes and fragrances, as described above, spatially separated from other constituents of the agent until they are used. An elegant method for incorporating such sensitive, chemically or physically incompatible or volatile ingredients is the use of microcapsules, in which these ingredients are enclosed in a storage-stable and transport-stable manner and from which they are released mechanically, chemically, thermally or enzymatically for or during use.

“Microcapsule,” as used herein, refers to capsules having a core-shell morphology on a micrometer scale, comprising a capsule shell which completely encloses a core. “Completely encloses” or “completely surrounds,” as used herein with reference to the microcapsules, means that the core is completely surrounded by the shell, i.e., it is in particular not embedded in a matrix such that it is exposed at any point. It is also preferable for the capsule shell to be such that the release of the contents is controlled, i.e., the contents are not released in a spontaneous and uncontrolled manner, irrespective of any release stimulus. For this reason, the capsule shell is preferably substantially impermeable to the encapsulated contents. “Substantially impermeable,” as used in this context, means that the contents of the capsule or individual ingredients cannot spontaneously pass through the shell, but rather the contents can only be released by the capsule being opened or optionally by means of a diffusion process that takes place over a long period of time. The core may be solid, liquid and/or gaseous, but is preferably solid and/or liquid. The microcapsules are preferably substantially spherical and have a diameter in the range of from 0.01 to 1,000 μm, in particular from 0.1 to 500 μm. The capsule shell and capsule core are made of different materials; in particular, under standard conditions (20° C., 1,013 mbar), the capsule shell is preferably solid, and the core is preferably solid and/or liquid, in particular liquid.

High-molecular compounds of animal or vegetable origin, e.g., protein compounds (gelatin, albumin, casein), cellulose derivatives (methylcellulose, ethylcellulose, cellulose acetate, cellulose nitrate, carboxymethylcellulose) and in particular synthetic polymers (e.g., polyamides, polyolefins, polyesters, polyurethanes, epoxy resins, silicone resins and condensation products of carbonyl- and NH group-containing compounds), for example, can very generally be used as the capsule material for the microcapsules. Specifically, the shell material may be selected, for example, from polyacrylates; polyethylene; polyamides; polystyrenes; polyisoprenes; polycarbonates; polyesters; polyureas; polyurethanes; polyolefins; polysaccharides; epoxy resins; vinyl polymers; urea cross-linked with formaldehyde or glutaraldehyde; melamine cross-linked with formaldehyde; gelatin-polyphosphate coacervates, optionally cross-linked with glutaraldehyde; gelatin-gum arabic coacervates; silicone resins; polyamines reacted with polyisocyanates; acrylate monomers polymerized by means of free radical polymerization; silk; wool; gelatin; cellulose; proteins; and mixtures and copolymers thereof. Polyacrylates, polyethylene, polyamides, polystyrenes, polyisoprenes, polycarbonates, polyesters, polyureas, polyurethanes, polyolefins, epoxy resins, vinyl polymers and urea and/or melamine cross-linked with formaldehyde or glutaraldehyde are particularly preferred.

Methods which are in principle suitable for producing suitable microcapsules are those known microencapsulation methods in which, for example, the phase to be encapsulated is encapsulated by being coated with film-forming polymers (such as those mentioned above) which precipitate on the material to be covered after emulsification and coacervation or interfacial polymerization. The phase to be encapsulated is a benefit agent composition, preferably a fragrance composition, usually in the form of a perfume oil.

The capsules can release the encapsulated benefit agents using various mechanisms. For example, in various embodiments, capsules can be used which have a mechanically stable capsule shell which then becomes permeable to the agents contained therein due to one or more environmental influences, such as changes in the temperature or the ionic strength or the pH of the surrounding medium. Stable capsule wall materials through which the at least one benefit agent, for example a perfume oil, and optionally further benefit agents, can diffuse over time are also possible. The capsules may release the at least one contained benefit agent preferably when the pH or the ionic strength of the environment changes, when the temperature changes, upon exposure to light, by diffusion and/or under mechanical stress.

In a preferred embodiment, the capsules are fragile, that is to say they can release the encapsulated agent due to mechanical stress, such as friction, pressure, or shear stress, which breaks the shell of the capsules. In another embodiment, the capsule is thermally labile, that is to say encapsulated substances may be released when the capsules are exposed to a temperature of at least 70° C., preferably at least 60° C., more preferably at least 50° C., and in particular at least 40° C.

In another preferred embodiment, the capsule for the encapsulated benefit agent(s) may become permeable after exposure to radiation of a certain wavelength, preferably by exposure to sunlight.

It is also possible that the capsules are fragile and at the same time thermally labile and/or unstable to radiation of a certain wavelength.

Suitable microcapsules can be water-soluble and/or water-insoluble, but are preferably water-insoluble capsules. The water-insolubility of the capsules has the advantage that they can withstand washing, cleaning or other treatment applications and can thus dispense the at least one benefit agent only after the aqueous washing, cleaning or treatment process, such as when drying, by means of a mere increase in temperature or due to sunlight or in particular friction on the surface.

Water-insoluble capsules which are broken up by friction are particularly preferred.

The term “abradable” capsules or capsules that are “breakable by friction” means in particular those capsules which, when they adhere to a surface treated therewith (e.g., a textile surface), can be opened or broken by mechanical friction or pressure, so that the contents are released only as a result of mechanical action, e.g., if someone dries their hands on a towel on which such capsules are deposited.

Advantageously usable, abradable capsules can have average diameters d₅₀ of <250 μm, preferably in the range of from 1 to 100 μm, more preferably between 3 and 95 μm, in particular between 4 and 90 μm, for example between 5 and 80 μm, for example between 5 and 40 μm. The d₅₀ value indicates the diameter which results when 50 wt. % of the capsules have a smaller diameter and 50 wt. % of the capsules have a larger diameter than the d₅₀ value determined. It is furthermore preferred for the d₅₀ value of the particle size distribution of the microcapsules to be <70 μm, preferably <60 μm, particularly preferably <50 m. The d₅₀ value of the particle size distribution is the value at which 90% of all particles are smaller and 10% of the particles are larger than this value.

The shell of the capsules enclosing the core or (filled) cavity preferably has an average thickness in the range between approximately 50 and 500 nm, preferably between approximately 100 nm and approximately 250 nm. Capsules are particularly abradable if they are within the ranges given above for the average diameter and the average thickness.

The d₅₀ value indicates the diameter which results when 50 wt. % of the capsules have a smaller diameter and 50 wt. % of the capsules have a larger diameter than the d₅₀ value determined. It is furthermore preferred for the d₅₀ value of the particle size distribution of the microcapsules to be <70 μm, preferably <60 μm, particularly preferably <50 m. The d₅₀ value of the particle size distribution is the value at which 90% of all particles are smaller and 10% of the particles are larger than this value.

The diameter of the capsules or the particle size of the microcapsules can be determined by conventional methods. It can be determined, for example, by means of dynamic light scattering, which can usually be carried out on dilute suspensions containing e.g., 0.01 to 1 wt. % of capsules. It can also be determined by evaluating light microscopic or electron microscopic images of capsules.

In various embodiments, a microcapsule has an average diameter d₅₀ of from approximately 1 to 80 μm, preferably approximately 5 to 40 μm, in particular approximately 20 to 35 μm, for example approximately 22 to approximately 33 μm.

The wall material of the microcapsules preferably comprises polyurethanes, polyolefins, polyamides, polyesters, polysaccharides, epoxy resins, silicone resins and/or polycondensation products of carbonyl compounds and NH group-containing compounds. This corresponds to a preferred embodiment. Melamine-urea-formaldehyde microcapsules or melamine-formaldehyde microcapsules or urea-formaldehyde microcapsules can be preferably used, for example. Particularly preferred are microcapsules based on melamine-formaldehyde resins.

The general approach to producing microcapsules as such has long been known to a person skilled in the art. Particularly suitable methods for producing microcapsules are described in principle in U.S. Pat. Nos. 3,516,941, 3,415,758 or EP 0 026 914 A1, for example. The document mentioned last describes, for example, producing microcapsules by acid-induced condensation of melamine-formaldehyde precondensates and/or the C1-C4 alkyl ethers thereof in water, in which the hydrophobic material forming the capsule core is dispersed, in the presence of a protective colloid.

Suitable thickeners include, for example, Aerosil types (hydrophilic silicas), polysaccharides, in particular xanthan gum, guar, agar, alginates and tyloses, carboxymethyl cellulose, methyl cellulose, hydroxypropyl cellulose, hydroxypropylmethyl cellulose and hydroxyethyl cellulose, and also higher-molecular-weight polyethylene glycol monoesters and diesters of fatty acids, polyacrylates (for example Carbopole® from Goodrich or Synthalene® from Sigma), polyacrylamides, polyvinyl alcohol and polyvinylpyrrolidone, surfactants such as ethoxylated fatty acid glycerides, esters of fatty acids with polyols such as pentaerythritol or trimethylol propane, fatty alcohol ethoxylates with a narrowed homolog distribution or alkyl oligoglucosides and electrolytes such as common salt and ammonium chloride.

In various embodiments, the at least one thickener is a non-ionic thickener, in particular is selected from the group comprising hydroxyethyl cellulose (HEC), hydroxypropyl cellulose (HPC), hydroxypropylmethyl cellulose (HPMC), methyl cellulose (MC), guar, guar derivatives (such as Jaguar HP105 (Rhodia); hydroxypropyl guar) and mixtures of the aforementioned non-ionic thickeners.

Alternatively, cationic thickeners can also be used. Examples of suitable cationic thickeners include, for example, those available under the trade name Rheavis® CSP (BASF).

In various embodiments, the at least one non-ionic or cationic thickener is contained in the agent in an amount of from 0.1 to 10 wt. %, based on the total weight of the formulation of the agent.

In various embodiments, the agent contains at least one emulsifier. The at least one emulsifier is preferably a non-ionic emulsifier and has an HLB value of at least 12.0, preferably of at least 13.0, more preferably of at least 14.0 and most preferably of at least 15.0.

The term “HLB” (hydrophilic-lipophilic balance) defines the hydrophilic and lipophilic portion of corresponding substance classes (here emulsifiers) in a value range of from 1 to 20 according to the following formula (Griffin, Classification of surface active agents by HLB, J. Soc. Cosmet. Chem. 1, 1949): HLB=20×(1−(M1/M)) where M=molar mass of the entire molecule and M1=molar mass of the lipophilic portion of the molecule.

Low HLB values (≥1) describe lipophilic substances; high HLB values (≤20) describe hydrophilic substances. For example, defoamers typically have HLB values in the range of from 1.5 to 3 and are insoluble in water. Emulsifiers for W/O emulsions typically have HLB values in the range of from 3-8, whereas emulsifiers for O/W emulsions typically have HLB values in the range of from 8-18. Washing-active substances typically have HLB values in the range of from 13-15 and solubilizers typically have values in the range of from 12-18.

The following non-ionic emulsifiers, for example, can be used as non-ionic emulsifiers for the agents, but is not limited to:
addition products of 2 to 50 mol ethylene oxide and/or 0 to 5 mol propylene oxide with linear fatty alcohols having 8 to 22 carbon atoms, with fatty acids having 8 to 22 carbon atoms, with alkylphenols having 8 to 15 carbon atoms in the alkyl group as well as alkylamines having 8 to 22 carbon atoms in the alkyl group; alkyl and/or alkenyl oligoglycosides having 8 to 22 carbon atoms in the alk(en)yl group and ethoxylated analogs thereof;
addition products of 1 to 15 mol ethylene oxide with castor oil and/or hydrogenated castor oil;
addition products of 15 to 60 mol ethylene oxide with castor oil and/or hydrogenated castor oil; partial esters of glycerol and/or sorbitan with unsaturated, linear or saturated, branched fatty acids having 12 to 22 carbon atoms and/or hydroxycarboxylic acids having 3 to 18 carbon atoms and adducts thereof with 1 to 30 mol ethylene oxide; partial esters of polyglycerol (average degree of self-condensation 2 to 8), polyethylene glycol (molecular weight 200 to 5,000), trimethylolpropane, pentaerythritol, sugar alcohols (e.g., sorbitol), alkyl glucosides (e.g., methyl glucoside, butyl glucoside, lauryl glucoside) and polyglucosides (e.g., cellulose) with saturated and/or unsaturated, linear or branched fatty acids having 12 to 22 carbon atoms and/or hydroxycarboxylic acids having 3 to 18 carbon atoms and adducts thereof with 1 to 30 mol ethylene oxide;
mixed esters of pentaerythritol, fatty acids, citric acid and fatty alcohol according to DE 1165574 PS and/or mixed esters of fatty acids having 6 to 22 carbon atoms, methyl glucose and polyols, preferably glycerol or polyglycerol.
mono-, di- and trialkyl phosphates and mono-, di- and/or tri-PEG-alkyl phosphates and salts thereof;
wool wax alcohols;
polysiloxane polyalkyl polyether copolymers or corresponding derivatives; and
polyalkylene glycols.

The addition products of ethylene oxide and/or propylene oxide with fatty alcohols, fatty acids, alkylphenols or with castor oil are known, commercially available products. These are homolog mixtures of which the average degree of alkoxylation corresponds to the ratio of the substance amounts of ethylene oxide and/or propylene oxide and substrate with which the addition reaction is carried out. 012/18 fatty acid mono- and diesters of addition products of ethylene oxide with glycerol are known from DE 2024051 PS as refatting agents for cosmetic preparations.

Alkyl oligoglycosides and/or alkenyl oligoglycosides, the preparation and the use thereof, are known from the prior art. They are prepared in particular by reacting glucose or oligosaccharides with primary alcohols having 8 to 18 carbon atoms. With regard to the glycoside residue, both monoglycosides, in which a cyclic sugar residue is glycosidically bound to the fatty alcohol, and oligomeric glycosides having a degree of oligomerization up to preferably approximately 8 are suitable. The degree of oligomerization is a statistical mean value based on a homolog distribution that is customary for such technical products.

Typical examples of suitable partial glycerides are hydroxystearic acid monoglyceride, hydroxystearic acid diglyceride, isostearic acid monoglyceride, isostearic acid diglyceride, oleic acid monoglyceride, oleic acid diglyceride, ricinoleic acid monoglyceride, ricinoleic acid diglyceride, linoleic acid monoglyceride, linoleic acid diglyceride, linolenic acid monoglyceride, linolenic acid diglyceride, erucic acid monoglyceride, erucic acid diglyceriede, tartaric acid monoglyceride, tartaric acid diglyceride, citric acid monoglyceride, citric diglyceride, malic acid monoglyceride, malic acid diglyceride, and technical mixtures thereof that may still contain small amounts of triglyceride as a result of the preparation process. Addition products of 1 to 30, preferably 5 to 10, mol ethylene oxide with the partial glycerides mentioned are also suitable.

Sorbitan monoisostearate, sorbitan sesquiisostearate, sorbitan diisostearate, sorbitan triisostearate, sorbitan monooleate, sorbitan sesquioleate, sorbitan dioleate, sorbitan trioleate, sorbitan monoerucate, sorbitan sesquierucate, sorbitan dierucate, sorbitan trierucate, sorbitan monoricinoleate, sorbitan sesquiricinoleate, sorbitan diricinoleate, sorbitan triricinoleate, sorbitan monohydroxystearate, sorbitan sesquihydroxystearate, sorbitan dihydroxystearate, sorbitan trihydroxystearate, sorbitan monotartrate, sorbitan sesquitartrate, sorbitan ditartrate, sorbitan tritartrate, sorbitan monocitrate, sorbitan sesquicitrate, sorbitan dicitrate, sorbitan tricitrate, sorbitan monomaleate, sorbitan sesquimaleate, sorbitan dimaleate, sorbitan trimaleate and technical mixtures thereof are used as sorbitan esters. Addition products of 1 to 30, preferably 5 to 10, mol ethylene oxide with the sorbitan esters mentioned are also suitable.

Typical examples of suitable polyglycerol esters are polyglyceryl-2 dipolyhydroxystearates (Dehymuls® PGPH), polyglycerol-3-diisostearates (Lameform® TGI), polyglyceryl-4 isostearates (Isolan® GI 34), polyglyceryl-3-oleates, diisostearoyl polyglyceryl-3 diisostearates (Isolan® PDI), polyglyceryl-3 methylglucose distearates (Tego Care® 450), polyglyceryl-3 beeswax (Cera Bellina®), polyglyceryl-4 caprates (Polyglycerol Caprate T2010/90), polyglyceryl-3 cetyl ethers (Chimexane® NL), polyglyceryl-3 distearates (Cremophor® GS 32) and polyglyceryl polyricinoleates (Admul® WOL 1403), polyglyceryl dimerate isostearates and mixtures thereof.

Examples of further suitable polyol esters are the mono-, di- and triesters of trimethylolpropane or pentaerythritol with lauric acid, coconut fatty acid, tallow fatty acid, palmitic acid, stearic acid, oleic acid, behenic acid and the like, optionally reacted with 1 to 30 mol ethylene oxide.

Instead of or in addition to the at least one non-ionic emulsifier, the agent can also contain further emulsifiers, for example cationic or anionic emulsifiers.

The known cationic emulsifiers include fatty acid amidoamines and/or quaternization products thereof.

Fatty acid amidoamines which are suitable as cationic emulsifiers are condensation products of fatty acids with optionally ethoxylated di- or oligoamines, which preferably follow formula (II), R¹CO—NR²—[(A)-NR³]ₙ—R⁴ (II), in which R¹CO represents a linear or branched, saturated or unsaturated acyl group having 6 to 22 carbon atoms, R² represents hydrogen or an optionally hydroxy-substituted alkyl group having 1 to 4 carbon atoms, R³ and R⁴ represent, independently of one another, hydrogen, a (CH₂CH₂O)ₘH group or an optionally hydroxy-substituted alkyl group having 1 to 4 carbon atoms, A represents a linear or branched alkylene group having 1 to 6 carbon atoms, n represents numbers from 1 to 4 and m represents numbers from 1 to 30. Typical examples are condensation products of caproic acid, caprylic acid, 2-ethylhexanoic acid, capric acid, lauric acid, isotridecanoic acid, myristic acid, palmitic acid, palm oleic acid, stearic acid, isostearic acid, oleic acid, elaidic acid, petroselinic acid, linoleic acid, linolenic acid, elaeostearic acid, arachidic acid, gadoleic acid, behenic acid and erucic acid, and technical mixtures thereof with ethylenediamine, propylenediamine, diethylenetriamine, dipropylenetriamine, triethylenetetramine, tripropylenetetramine and adducts thereof with 1 to 30, preferably 5 to 15 and in particular 8 to 12 mol ethylene oxide. The use of ethoxylated fatty acid amidoamines is preferred because the hydrophilicity of the emulsifiers can thus be adjusted exactly to the active ingredients to be emulsified.

Instead of the fatty acid amidoamines, it is also possible to use the quaternization products thereof which are obtained by reacting the amidoamines with suitable alkylating agents, such as methyl chloride or, in particular, dimethyl sulfate, by methods known per se. The quaternization products preferably follow formula (III), [R¹CO—NR²—[(A)-N⁺R³R⁶)ₙ—R⁴]X⁻ (III), in which R¹CO represents a linear or branched, saturated or unsaturated acyl group having 6 to 22 carbon atoms, R² represents hydrogen or an optionally hydroxy-substituted alkyl group having 1 to 4 carbon atoms, R³ represents hydrogen, a (CH₂CH₂O)ₘH group or an optionally hydroxy-substituted alkyl group having 1 to 4 carbon atoms, R⁴ represents R¹CO, hydrogen, a (CH₂CH₂O)ₘH group or an optionally hydroxy-substituted alkyl group having 1 to 4 carbon atoms, R⁶ represents an alkyl group having 1 to 4 carbon atoms, A represents a linear or branched alkylene group having 1 to 6 carbon atoms, n represents numbers from 1 to 4, m represents numbers from 1 to 30 and X represents halide, especially chloride, or alkyl sulfate, preferably methyl sulfate. The methylation products of the preferred fatty acid amidoamines mentioned above are suitable for this purpose, for example. It is also possible to use mixtures of fatty acid amidoamines and the quaternization products thereof, which are particularly easy to prepare by not carrying out the quaternization completely, but only to a desired degree.

The agent can contain the fatty acid amidoamines and/or the quaternization products thereof in amounts of from 0.1 wt. % to 50 wt. %, preferably 1 wt. % to 30 wt. % and in particular 2 wt. % to 10 wt. %, based on the final concentration.

Other known emulsifiers include the betaines. Betaines are known surfactants which are mainly produced by carboxyalkylation, preferably carboxymethylation, of aminic compounds. The starting materials are preferably condensed with halogenated carboxylic acids or the salts thereof, in particular with sodium chloroacetate, one mole of salt being formed per mole of betaine. The addition of unsaturated carboxylic acids, such as acrylic acid, is also possible. Regarding the nomenclature and in particular the distinction between betaines and “real” amphoteric surfactants, reference is made to the paper by U. Ploog in Seifen-Öle-Fette-Wachse, 108, 373 (1982). Further overviews on this topic can be found, for example, from A. O'Lennick et al. in HAP-PI, November 70 (1986), S. Holzman et al. in Tens. Surf. Det. 23, 309 (1986), R. Bibo et al. in Soap Cosm. Chem. Spec, April 46 (1990) and P. Ellis et al. in Euro Cosm. 1, 14 (1994). Examples of suitable betaines are the carboxyalkylation products of secondary and, in particular, tertiary amines which follow formula (IV), R⁷—N⁺(R⁸)(R⁹)—(CH₂)ₚCOOA (IV), in which R⁷ represents alkyl and/or alkenyl groups having 6 to 22 carbon atoms, R⁸ represents hydrogen or alkyl groups having 1 to 4 carbon atoms, R⁹ represents alkyl groups having 1 to 4 carbon atoms, p represents numbers from 1 to 6 and A represents an alkali metal and/or alkaline earth metal or ammonium. Typical examples are the carboxymethylation products of hexyl methyl amine, hexyl dimethyl amine, octyl dimethyl amine, decyl dimethyl amine, dodecyl methyl amine, dodecyl dimethyl amine, dodecyl ethyl methyl amine, C_{12/14} coco alkyl dimethyl amine, myristyl dimethyl amine, cetyl dimethyl amine, stearyl dimethyl amine, stearyl ethyl methyl amine, oleyl dimethyl amine, C_{16/18} tallow alkyl dimethyl amine and technical mixtures thereof.

Carboxyalkylation products of amidoamines which follow formula (V), R¹⁰CO—NH—(CH₂)ₘ—N⁺(R⁸)(R⁹)—(CH₂)ₚCOOA (V), in which R¹⁰CO represents an aliphatic acyl group having 6 to 22 carbon atoms and 0 or 1 to 3 double bonds, m represents numbers from 1 to 3 and R³, R⁹, p and A have the meanings given above, can also be used. Typical examples are reaction products of fatty acids having 6 to 22 carbon atoms, namely caproic acid, caprylic acid, capric acid, lauric acid, myristic acid, palmitic acid, palmoleic acid, stearic acid, isostearic acid, oleic acid, elaidic acid, petroselinic acid, linoleic acid, linolenic acid, elaeostearic acid, arachidic acid, gadoleic acid, behenic acid and erucic acid and the technical mixtures thereof, with N,N-dimethylaminoethylamine, N,N-dimethylaminopropylamine, N,N-diethylaminoethylamine and N,N-diethylaminopropylamine, which are condensed with sodium chloroacetate. The use of a condensation product of C_{8/18} coconut fatty acid-N,N-dimethylaminopropylamide with sodium chloroacetate is preferred.

Furthermore, also suitable as starting materials are imidazolines which follow formula (VI),

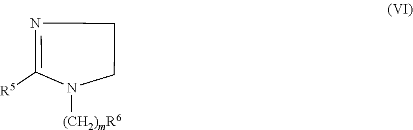

in which R⁵ represents an alkyl group having 5 to 21 carbon atoms, R⁶ represents a hydroxyl group, an OCOR⁵ group or NHCOR⁵ group, and m represents 2 or 3. These substances are also known substances that can be obtained, for example, by cyclizing condensation of 1 or 2 mol fatty acid with polyvalent amines, such as aminoethylethanolamine (AEEA) or diethylenetriamine. The corresponding carboxyalkylation products are mixtures of different open-chain betaines. Typical examples are condensation products of the abovementioned fatty acids with AEEA, preferably imidazolines based on lauric acid or 012/14 coconut fatty acid, which are then betainized with sodium chloroacetate.

An agent can contain the betaines in amounts of from 0.1 to 50, preferably 1 to 30 and in particular 2 to 10 wt. %, based on the final concentration.

The agent can contain combinations of non-ionic emulsifiers with further non-ionic emulsifiers, anionic emulsifiers and/or cationic emulsifiers, the HLB value of the emulsifier mixture of the (at least one) first and (at least one) second emulsifier preferably being at least 12.0, particularly preferably at least 14.0, most preferably at least 15.0. The ratio of the first emulsifier to the second emulsifier is preferably 0.9 to 0.1 to 0.9 to 0.1. In a particularly preferred embodiment, the second emulsifier is also a non-ionic emulsifier.

In various embodiments, the agent also contains at least one non-aqueous solvent selected from (poly)alkylene glycols or alcohols, for example from the group of monohydric or polyhydric alcohols. Alkanolamines or glycol ethers can also be used, provided they are miscible with water in the concentration range used. The solvents are preferably selected from ethanol, n-propanol or i-propanol, butanols, glycol, propanediol or butanediol, glycerol, diglycol, propyl diglycol or butyl diglycol, ethylene glycol methyl ether, ethylene glycol ethyl ether, ethylene glycol propyl ether, ethylene glycol mononbutyl ether, diethylene glycol methyl ether, diethylene glycol ethyl ether, propylene glycol methyl ether or propylene glycol ethyl ether or propylene glycol propyl ether, dipropylene glycol methyl ether or dipropylene glycol ethyl ether, methoxytriglycol or ethoxytriglycol or butoxytriglycol, 1-butoxyethoxy-2-propanol, 3-methyl-3-methoxybutanol, propylene-glycoltbutyl ether, and mixtures of these solvents. In preferred embodiments, the at least one non-aqueous solvent is selected from ethanol, propylene glycol, dipropylene glycol, glycerol and isopropanol.

In further embodiments, the agent also contains at least one hydrotropic substance. Aromatic alkyl sulfonates, such as in particular toluene sulfonates, cumene sulfonates, xylene sulfonates, inter alia, can be used as hydrotropic substances. In various embodiments, the at least one hydrotropic substance is in particular an aromatic alkyl sulfonic acid or an ester or salt thereof, preferably selected from p-toluenesulfonic acid methyl ester, p-toluenesulfonic acid monohydrate and p-cumene sulfonic acid or the corresponding salts, in particular the sodium salts.

In order to bring the pH of the agent into the desired range, the use of pH adjusting agents may be indicated. All known acids or alkalis can be used here, provided that their use is not prohibited for practical or ecological reasons or for reasons of consumer protection. The amount of these adjusting agents usually does not exceed 1 wt. % of the total formulation.

Dyes are added to the agent in order to improve the aesthetic impression of the product and to provide the consumer with a visually “characteristic and unmistakable” product. The content of dyes is usually below 0.01 wt. % of the formulation of the agent. Preferred dyes, which can be selected by a person skilled in the art without difficulty, are highly stable in storage, are unaffected by the other ingredients of the agent, are insensitive to light, and do not have pronounced substantivity with respect to textile fibers, in order to avoid dyeing said fibers.

Foam inhibitors which can be used in the agent are, for example, soaps, paraffins or silicone oils, which can optionally be applied to carrier materials. Suitable anti-redeposition agents, which are also referred to as soil repellents, are for example, non-ionic cellulose ethers, such as methylcellulose and methyl hydroxypropyl cellulose, having a proportion of methoxy groups of 15 to 30 wt. % and of hydroxypropyl groups of 1 to 15 wt. %, in each case based on the non-ionic cellulose ether, and the polymers of phthalic acid and/or terephthalic acid known from the prior art, or derivatives thereof, in particular polymers of ethylene terephthalates and/or polyethylene glycol terephthalates or anionically and/or non-ionically modified derivatives thereof. Of these, the sulfonated derivatives of phthalic acid polymers and terephthalic acid polymers are particularly preferred.

To improve the flow behavior, further hydrotropic substances such as ethanol, isopropyl alcohol or polyols can be used in addition to the abovementioned substances. Polyols which can be used here preferably have 2 to 15 carbon atoms and at least two hydroxyl groups. The polyols can also contain further functional groups, in particular amino groups, or be modified with nitrogen. Typical examples are:
glycerol,
alkylene glycols, such as ethylene glycol, diethylene glycol, propylene glycol, butylene glycol, hexylene glycol and polyethylene glycols having an average molecular weight of 100 to 1,000 daltons,
technical oligoglycene mixtures having a degree of self-condensation of 1.5 to 10 such as technical diglycene mixtures having a diglycene content of 40 to 50 wt. %,
methylol compounds, such as, in particular, trimethylolethane, trimethylolpropane, trimethylolbutane, pentaerythritol and dipentaerythritol,
lower alkyl glucosides, in particular those having 1 to 8 carbons in the alkyl group, such as methyl glucoside and butyl glucoside,
sugar alcohols having 5 to 12 carbon atoms, such as sorbitol or mannitol,
sugars having 5 to 12 carbon atoms, such as glucose or sucrose,
amino sugars, such as glucamine,
dialcohol amines such as diethanolamine or 2-amino-1,3-propanediol.

In particular enzymes from the class of hydrolases such as proteases, esterases, lipases or lipolytically active enzymes, amylases, cellulases or other glycosyl hydrolases and mixtures of the named enzymes are suitable enzymes. All these hydrolases contribute to the removal of stains on laundry such as stains and graying containing protein, fat or starch. Cellulases and other glycosyl hydrolases can also contribute to the removal of pilling and microfibrils to maintain color and increase the softness of the textile. Also, oxireductases can be used for bleaching or preventing dye transfer. Enzymatic active ingredients obtained from bacterial strains or fungi, such as Bacillus subtilis, Bacillus licheniformis, Streptomyceus griseus and Humicola insolens, are particularly suitable. Preferably, subtilisin-type proteases and in particular proteases obtained from Bacillus lentus are used. Mixtures of enzymes, for example proteases and amylases or proteases and lipases or lipolytically active enzymes or proteases and cellulases, or cellulases and lipases or lipolytically active enzymes, or proteases, amylases and lipases or lipolytically active enzymes or proteases, lipases or lipolytically active enzymes and cellulases, but in particular mixtures containing proteases and/or lipases, or mixtures with lipolytically active enzymes, are of particular interest. Examples of such lipolytically active enzymes are the known cutinases. Also, peroxidases or oxidases have proved suitable in some cases. Suitable amylases include in particular α-amylases, isoamylases, pullulanases and pectinases. Preferably cellobiohydrolases, endoglucanases and β-glucosidases which are also called cellobiases, or mixtures thereof, are used as cellulases. Since the different types of cellulases differ in terms of their CMCase and avicelase activities, the desired activities can be adjusted by targeted mixtures of cellulases.

The enzymes may be adsorbed to substrates or embedded in coating substances to prevent them from decomposing prematurely. The proportion of enzymes, enzyme mixtures or enzyme granulates may be, for example, of from approximately 0.1 to 5 wt. %, preferably 0.12 to approximately 2 wt. %.

Optical brighteners (so-called “whiteners”) can be added to the agents in order to remove graying and yellowing of the treated textiles. These substances are adsorbed to the fiber and have a brightening and simulated bleaching effect by converting invisible ultraviolet radiation into visible longer-wave light, the ultraviolet light absorbed from the sunlight being emitted as slightly bluish fluorescence and, together with the yellow tone of the grayed or yellowed laundry, produces pure white. Suitable compounds originate, for example, from the substance classes of 4,4′-diamino-2,2′-stilbene disulfonic acids (flavonic acids), 4,4′-distyryl-biphenylene, methylumbelliferones, coumarins, dihydroquinolinones, 1,3-diarylpyrazolines, naphthalic acid imides, benzoxazole, benzisoxazole and benzimidazole systems and the pyrene derivatives substituted by heterocycles. The optical brighteners are usually used in amounts between 0.1 and 0.3 wt. %, based on the finished agent.

The function of graying inhibitors is to keep the dirt that is removed from the fiber suspended in the liquor and in this way prevent redeposition of the dirt. Water-soluble colloids, which are usually organic, are suitable for this purpose, for example the water-soluble salts of polymeric carboxylic acids, sizing material, gelatin, salts of ethersulfonic acids of starch or of cellulose, or salts of acidic sulfuric acid esters of cellulose or of starch. Water-soluble polyamides containing acid groups are also suitable for this purpose. Furthermore, soluble starch preparations and starch products other than those mentioned above can be used, for example degraded starch, aldehyde starches, etc. Polyvinylpyrrolidone is also suitable.

Cellulose ethers such as carboxymethylcellulose (Na salt), methylcellulose, hydroxyalkylcellulose, and mixed ethers such as methylhydroxyethylcellulose, methylhydroxypropylcellulose, methylcarboxymethylcellulose and mixtures thereof, are used in amounts of 0.1 to 5 wt. %, based on the formulation of the agent.

Since textile fabrics, in particular made of rayon, viscous staple fiber, cotton and mixtures thereof, can tend to crease because the individual fibers are sensitive to bending, kinking, pressing and squeezing transversely to the fiber direction, the agents can contain synthetic anti-crease agents. These include, for example, synthetic products based on fatty acids, fatty acid esters, fatty acid amides, fatty acid alkylol esters, fatty acid alkylol amides or fatty alcohols, which are mostly reacted with ethylene oxide, or products based on lecithin or modified phosphoric acid esters.

To combat microorganisms, the agent can contain antimicrobial active ingredients. Here, depending on the antimicrobial spectrum and mechanism of action, a distinction is made between bacteriostatic and bactericidal agents, fungistatic and fungicidal agents, etc. Important substances from these groups are, for example, benzalkonium chlorides. Non-limiting compounds are, for example, alkyl aryl sulfonates, halophenols and phenol mercuric acetate, although it is possible to do entirely without these compounds in the agents.

The agent can contain preservatives, although preferably only those which have little or no skin-sensitizing potential are used. Examples are sorbic acid and the salts thereof, benzoic acid and the salts thereof, salicylic acid and the salts thereof, phenoxyethanol, 3-iodo-2-propynyl butyl carbamate, sodium N-(hydroxymethyl)glycinate, biphenyl-2-ol and mixtures thereof. A suitable preservative is the solvent-free, aqueous combination of diazolidinyl urea, sodium benzoate and potassium sorbate (available as Euxyl® K 500 ex Schuelke & Mayr), which can be used in a pH range of up to 7. In particular, preservatives based on organic acids and/or the salts thereof are suitable for preserving the agent.

In order to prevent undesired changes to the agent and/or the treated textile fabrics caused by the action of oxygen and other oxidative processes, the agent can contain antioxidants. This compound class includes, for example, substituted phenols, hydroquinones, catechols and aromatic amines as well as organic sulfides, polysulfides, dithiocarbamates, phosphites, phosphonates and vitamin E.

Increased wearing comfort can result from the additional use of antistatic agents which are additionally added to the agent. Antistatic agents increase the surface conductivity and thus enable the charges that have formed to flow off better. External antistatic agents are generally substances having at least one hydrophilic molecular ligand and give the surfaces a more or less hygroscopic film. These mostly surface-active antistatic agents can be divided into nitrogen-containing (amines, amides, quaternary ammonium compounds), phosphorus-containing (phosphoric acid esters) and sulfur-containing (alkyl sulfonates, alkyl sulfates) antistatic agents. External antistatic agents are described in patent applications FR 1,156,513, GB 873 214 and GB 839 407, for example. The lauryl (or stearyl) dimethyl benzyl ammonium chlorides disclosed here are suitable as antistatic agents for textiles, with an additional avivage effect being achieved.

The agent can also contain UV absorbers which are adsorbed onto the treated textiles and improve the light-fastness of the fibers. Compounds which have these desired properties are, for example, the compounds and derivatives of benzophenone which have substituents in the 2- and/or 4-position and are effective by radiationless deactivation. Substituted benzotriazoles, acrylates (cinnamic acid derivatives) that are phenyl-substituted in the 3-position, optionally having cyano groups in the 2 position, salicylates, organic Ni complexes and natural substances such as umbelliferone and the endogenous urocanic acid are also suitable.

In order to effectively suppress dye detachment and/or dye transfer to other textile fabrics during the conditioning of dyed textile fabrics, an agent can contain a dye transfer inhibitor. It is preferable for the dye transfer inhibitor to be a polymer or a copolymer of cyclic amines such as vinylpyrrolidone and/or vinylimidazole. Polymers that are suitable as the dye transfer inhibitor include polyvinylpyrrolidone (PVP), polyvinylimidazole (PVI), copolymers of vinylpyrrolidone and vinylimidazole (PVP/PVI), polyvinylpyridine-N-oxide, poly-N-carboxymethyl-4-vinylpyridium chloride and mixtures thereof. Particularly preferably, polyvinylpyrrolidone (PVP), polyvinylimidazole (PVI) or copolymers of vinylpyrrolidone and vinylimidazole (PVP/PVI) are used as the dye transfer inhibitor. The polyvinylpyrrolidones (PVP) used preferably have an average molecular weight of from 2,500 to 400,000 and are commercially available from ISP Chemicals as PVP K 15, PVP K 30, PVP K 60 or PVP K 90, or from BASF as Sokalan® HP 50 or Sokalan® HP 53. The copolymers of vinylpyrrolidone and vinylimidazole (PVP/PVI) used preferably have a molecular weight in the range of from 5,000 to 100,000. A PVP/PVI copolymer is commercially available from BASF under the name Sokalan® HP 56, for example.

The amount of dye transfer inhibitor, based on the total amount of the agent, is preferably of from 0.01 wt. % to 2 wt. %, more preferably from 0.05 wt. % to 1 wt. % and more preferably from 0.1 wt. % to 0.5 wt. %.

However, it is alternatively also possible for enzymatic systems comprising a peroxidase and hydrogen peroxide or a substance which produces hydrogen peroxide in water to be used as the dye transfer inhibitor. The addition of a mediator compound for the peroxidase, for example an acetosyringone, a phenol derivative or a phenotiazine or phenoxazine, is preferred in this case, although it is also possible to additionally use the above-mentioned polymeric dye transfer inhibitors.

In order to avoid the decomposition, catalyzed by heavy metals, of particular ingredients, substances can be used that complex heavy metals. Suitable heavy metal complexing agents are, for example, the alkali salts of ethylenediaminetetraacetic acid (EDTA) or nitrilotriacetic acid (NTA) and alkali metal salts of anionic polyelectrolytes such as polymaleates and polysulfonates.

A preferred class of complexing agents are the phosphonates, which are contained in preferred agents in amounts of from 0.01 wt. % to 2.5 wt. %, preferably 0.02 wt. % to 2 wt. % and in particular from 0.03 wt. % to 1.5 wt. %. These preferred compounds include in particular organophosphonates such as 1-hydroxyethane-1,1-diphosphonic acid (HEDP), aminotri(methylenephosphonic acid) (ATMP), diethylenetriaminepenta(methylenephosphonic acid) (DTPMP or DETPMP) and 2-phosphonobutane-1,2,4 tricarboxylic acid (PBS-AM), which are mostly used in the form of their ammonium or alkali metal salts.

In some embodiments, the textile treatment agents described herein are preferably pre-packaged into metering units. These metering units preferably comprise the amount of washing-active or care-active substances necessary for a cleaning cycle. In some embodiments, suitable metering units have a weight between 12 and 30 g, for example. The volume of the aforementioned metering units and the three-dimensional shape thereof are particularly preferably selected so that the pre-packaged units can be metered via the metering chamber of a washing machine. The volume of the metering unit is therefore preferably between 10 and 35 ml, more preferably between 12 and 30 ml.

The agents, in particular the prefabricated metering units, particularly preferably have a water-soluble coating. In some embodiments, an agent as described herein is in the form of a unit dose, as previously described. In preferred embodiments, such an agent is in particular wrapped in a water-soluble film.

The water-soluble wrapping is preferably made from a water-soluble film material, which is selected from the group consisting of polymers or polymer mixtures. The wrapping may be made up of one or of two or more layers of the water-soluble film material. The water-soluble film material of the first layer and of the additional layers, if present, may be the same or different. Particularly preferred are films which, for example, can be glued and/or sealed to form packaging such as tubes or sachets after they have been filled with an agent. In various embodiments, the films are in the form of multi-chamber pouches.

It is preferable for the water-soluble wrapping to contain polyvinyl alcohol or a polyvinyl alcohol copolymer. Water-soluble wrappings containing polyvinyl alcohol or a polyvinyl alcohol copolymer exhibit good stability with a sufficiently high level of water solubility, in particular cold-water solubility.

Suitable water-soluble films for producing the water-soluble wrapping are preferably based on a polyvinyl alcohol or a polyvinyl alcohol copolymer of which the molecular weight is in the range of from 10,000 to 1,000,000 gmol⁻¹, preferably from 20,000 to 500,000 gmol⁻¹, particularly preferably from 30,000 to 100,000 gmol⁻¹ and in particular from 40,000 to 80,000 gmol⁻¹.

Polyvinyl alcohol is usually prepared by hydrolysis of polyvinyl acetate, since the direct synthesis route is not possible. The same applies to polyvinyl alcohol copolymers, which are prepared accordingly from polyvinyl acetate copolymers. It is preferable for at least one layer of the water-soluble wrapping to include a polyvinyl alcohol of which the degree of hydrolysis is 70 to 100 mol. %, preferably 80 to 90 mol. %, particularly preferably 81 to 89 mol. %, and in particular 82 to 88 mol. %.

In addition, a polymer selected from the group including (meth)acrylic acid-containing (co)polymers, polyacrylamides, oxazoline polymers, polystyrene sulfonates, polyurethanes, polyesters, polyethers, polylactic acid or mixtures of said polymers may be added to a polyvinyl alcohol-containing film material that is suitable for producing the water-soluble wrapping. Polylactic acids are a preferred additional polymer.

Preferred polyvinyl alcohol copolymers include, in addition to vinyl alcohol, dicarboxylic acids as further monomers. Suitable dicarboxylic acids are itaconic acid, malonic acid, succinic acid and mixtures thereof, itaconic acid being preferred.

Polyvinyl alcohol copolymers which include, in addition to vinyl alcohol, an ethylenically unsaturated carboxylic acid, or the salt or ester thereof, are also preferred. Polyvinyl alcohol copolymers of this kind particularly preferably contain, in addition to vinyl alcohol, acrylic acid, methacrylic acid, acrylic acid ester, methacrylic acid ester or mixtures thereof.

It may be preferable for the film material to contain further additives. The film material may contain plasticizers such as dipropylene glycol, ethylene glycol, diethylene glycol, propylene glycol, glycerol, sorbitol, mannitol or mixtures thereof, for example. Further additives include, for example, release aids, fillers, cross-linking agents, surfactants, antioxidants, UV absorbers, anti-blocking agents, anti-adhesive agents or mixtures thereof.

Suitable water-soluble films for use in the water-soluble wrappings of the water-soluble packaging are films which are sold by MonoSol LLC, for example under the names M8630, C8400 or M8900. Other suitable films include films named Solublon® PT, Solublon® GA, Solublon® KC or Solublon® KL from Aicello Chemical Europe GmbH, or the VF-HP films from Kuraray.

The textile treatment agent may be used, as described above, for textile care and/or conditioning purposes, as defined herein. In particular, an agent may be used, as described herein for conditioning, in particular for softening, textiles. A textile treatment agent may be used in a manual textile treatment method or, preferably, in the washing machine.

A manual or preferably machine method may be used for conditioning textiles, characterized in that at least one dispersion of at least one cationically modified polyurethane and/or at least one textile treatment agent, as described herein, is used in at least one method step.

In particular, a method may include applying a dispersion of at least one cationically modified polyurethane to textiles, the dispersion being added in pure form, or as a constituent of a textile treatment agent as described herein, together with the textiles, into a household washing machine or an industrial washing machine, and undergoing a washing program, such that the dispersion of at least one cationically modified polyurethane is released into the rinsing liquor and can then precipitate onto the textiles.

A dispersion of a cationically modified polyurethane or a textile treatment agent containing such a dispersion can in principle also advantageously be used in corresponding methods in combination with other textile washing agents and/or care agents. In various embodiments, a washing agent is also used in addition to the at least one dispersion or the at least one textile treatment agent.

All aspects, objects and embodiments described for the use/agent are also applicable to the above-mentioned subjects. Therefore, reference is expressly made at this point to the disclosure at the appropriate point with the note that this disclosure also applies to the above-described uses and methods.

### EXAMPLES

### Example 1: Synthesis of the Cationic Salt

### Step 1:

Glycidol (25 g, 0.34 mol), trimethylamine hydrochloride (32.5 g, 0.34 mol) and N,N-diisopropylethylamine (59.22 ml, 0.34 mol) were stirred for 12 h at room temperature in anhydrous methanol (220 ml). The solvent was removed under reduced pressure, then the residue was purified by recrystallization from EtOH/acetone (1:1 v/v), giving 2,3-dihydroxy-N,N,N-trimethylpropane-1-ammonium chloride as a white powder (50 g, yield=88%).

### Step 2:

2,3-Dihydroxy-N,N,N-trimethylpropane-1-ammonium chloride (10 g, 59 mmol) and 1,2-epoxybutane (20.6 ml, 236 mmol) were reacted in the presence of potassium hydroxide (200 mg, 0.6 mmol) in an autoclave at 120° C. for 24 h. The cationic ammonium diol was obtained as a yellow oil (22 g, yield=92%).

### Preparation of the Prepolymer:

Realkyd XTR 20112 from Arkema (75.22 g, Mw 2,074 g/mol; adipic acid/butylene glycol polyester polyol), Realkyd XTR 10110 from Arkema (6.45 g, Mw 1,000 g/mol; adipic acid/butylene glycol polyester polyol), cationic ammonium diol (2.44 g, Mw 400 g/mol) and K-HN-8200 (4.08 g, Mw 1,941 g/mol; polyether, Mₙ approx. 2,000 g/mol, 80% EO, Hannong Chemicals) were added into a 250 ml round-bottom flask, which was equipped with a mechanical stirrer and a condenser. The heterogeneous mixture was heated to 75° C. (bath temperature) until Realkyd XTR 20112 and XTR 10110 melted together with the remainder of the components. The mixture was dried under vacuum for 1 to 2 hours. The mixture was allowed to cool to 60° C. DN-9805 (0.35 g, 504 g/mol; hexamethylene diisocyanate-based polyisocyanate of the isocyanurate type, manufactured by DIC Corporation, isocyanate group content 21 wt. %, non-volatile content: 100 wt. %), isophorone diisocyanate (5.50 g, Mw 222.29 g/mol) and hexamethylene diisocyanate (6.25, Mw 168 g/mol) were added to the reaction mixture. The mixture was then heated to 85° C. and the catalyst (DBTDL catalyst, 3.8 mg dissolved in 3.87 g acetone) was added. Thereafter, the reaction was left at 85° C. for 3 hours. Acetone (123.7 g) was added in two portions and stirred to give a clear solution. The solution was stored under a nitrogen atmosphere overnight.

### Emulsification:

The reaction mixture was heated to 40° C. and warm water (111 g) was added, and the emulsion was stirred at 400 rpm for 10 minutes.

### Chain Extension:

An aqueous solution of ethylenediamine (10 wt. %) was added until the isocyanate group was completely converted (determined by ATR).

Acetone was removed under vacuum to give the final water-based polyurethane dispersion.

### Example 2: Evaluation of Softness

3.5 kg of a cotton-containing laundry load was washed in a front loading washing machine using a commercially available washing agent. The dispersion from Example 1 was used in the last rinsing step. After drying, the softness of the laundry load was evaluated by trained experts in comparison with laundry rinsed using water only (0=very hard, 6=very soft).

TABLE 1
Evaluation of softness

| Test condition | Water | 1% dispersion* | 2% dispersion* |
|---|---|---|---|
| Softness | 2.2 | 3.1 | 3.2 |

*wt. % in each case based on 3.5 kg of laundry

1. A method of forming a textile treatment agent, wherein the method comprises:
emulsifying at least one cationically modified prepolymer into an aqueous phase; and
cross-linking the emulsified prepolymer to form the dispersion having the at least one cationically modified polyurethane.

2. The method according to claim 1, wherein the at least one cationically modified prepolymer is obtained by reacting:
at least one organic compound (A) comprising:
at least one isocyanate-reactive functional group, and
at least one cationic functional group or a salt of compound (A);
with
at least one polyisocyanate compound (B), and optionally
at least one polyol compound (C).

3. The method according to claim 2, wherein:
compound (A) is an organic compound (A) of the formula
(N⁺(R)₃)—X (I),
wherein each R is independently H or a straight-chain, cyclic or branched, saturated or unsaturated, or aromatic hydrocarbon group having up to 50 carbon atoms and optionally comprises one or more groups selected from —O—, —(CO)—, and —NH—;
X is selected from the group consisting of straight-chain, cyclic or branched, saturated, unsaturated or aromatic, substituted or unsubstituted hydrocarbon groups having up to 5,000 carbon atoms and comprising at least one —O—(Y)ₙ—H group, wherein Y in each —O—(Y)ₙ—H group is, with each occurrence, independently selected from the group consisting of EO, PO, and BO, and n denotes an integer from 1 to 100, and further optionally comprises one or more groups selected from —O—, —(CO)—, —NH—, and —NR¹₂—; wherein each R¹ is independently selected from the group consisting of straight-chain, cyclic or branched, saturated, unsaturated, or aromatic, substituted or unsubstituted hydrocarbon groups having up to 20 carbon atoms; and/or
compound (B) selected from di- and triisocyanate compounds and isocyanate compounds suitable as cross-linkers.

4. The method according to claim 3, wherein:
at least one compound (A), at least one compound (B), and optionally at least one compound (C) are reacted in the presence of at least one catalyst;
the at least one isocyanate compound (B) comprises or consists of aliphatic di- and triisocyanate compounds;
the at least one polyol compound (C) is selected from the group consisting of polyester polyols, polyether polyols, polycarbonate polyols, polysiloxane polyols, and polyolefin polyols; and
combinations thereof.

5. The method according to claim 1, wherein the emulsifying takes place at a temperature ranging from about 27 to about 95° C.

6. A textile treatment agent composition obtained from the method of claim 1 comprising the textile treatment agent.

7. The textile treatment agent composition according to claim 6, wherein the dispersion of at least one cationically modified polyurethane has a viscosity ranging from about 100 to about 1,000 mPas.

8. The textile treatment agent composition according to claim 6, wherein the textile treatment agent composition is a fabric softener.

9. The textile treatment agent composition according to claim 8, wherein the proportion of the at least one dispersion of at least one cationically modified polyurethane ranges from about 5 to about 25 wt. % in each case based on the total weight of the textile treatment agent composition.

10. The textile treatment agent composition according to claim 6, further comprising at least one additional component selected from the group consisting of additional softening compounds, fragrances, surfactants, thickeners, emulsifiers, hydrotropic substances, non-aqueous solvents, electrolytes, pH adjusters, perfume carriers, fluorescent agents, dyes, foam inhibitors, anti-redeposition agents, enzymes, optical brighteners, graying inhibitors, anti-shrink agents, anti-crease agents, dye transfer inhibitors, antimicrobial active ingredients, germicides, fungicides, antioxidants, corrosion inhibitors, antistatic agents, ironing aids, repellents and impregnating agents, anti-swelling and anti-slip agents, UV absorbers, and combinations thereof.

11. A method for conditioning textiles, wherein the method comprises:
applying the textile treatment agent of claim 1 to a textile.
